(19) United States
(12) Patent Application Publication
(10) Pub. No.: US 2023/0055781 A1
(43) Pub. Date: Feb. 23, 2023

(54) POSITIVE ELECTRODE ACTIVE MATERIAL, SECONDARY BATTERY, AND ELECTRONIC DEVICE

(71) Applicant: SEMICONDUCTOR ENERGY LABORATORY CO., LTD., ATSUGI-SHI, KANAGAWA-KEN (JP)

(72) Inventors: Yohei MOMMA, Isehara, Kanagawa (JP); Toshikazu OHNO, Atsugi, Kanagawa (JP); Yoshihiro KOMATSU, Ebina, Kanagawa (JP); Shunpei YAMAZAKI, Setagaya, Tokyo (JP)

(21) Appl. No.: 17/759,165

(22) PCT Filed: Jan. 19, 2021
(86) PCT No.: PCT/IB2021/050361

§ 371 Date: Jul. 20, 2022

(30) Foreign Application Priority Data
Jan. 31, 2020 (JP) 2020-014716

(51) Int. Cl. H01M 4/525; H01M 10/0525

(52) U.S. Cl. CPC H01M 4/525; H01M 10/0525; H01M 2004/028

(57) ABSTRACT

The breakage or cracking of a positive electrode active material due to pressure application, repeated charging and discharging, or the like is likely to cause dissolution of a transition metal, an excessive side reaction, and the like. With a crack, unevenness, a step, roughness, or the like on the surface of a positive electrode active material, stress tends to be concentrated on part, which easily causes breakage. By contrast, with a smooth surface and a nearly spherical shape, stress concentration is alleviated; thus, breakage is unlikely to occur. Therefore, a positive electrode active material with a smooth surface and little unevenness is formed. For example, when the positive electrode active material is subjected to image analysis using a microscope image, the median value of the solidity is larger than or equal to 0.96. Alternatively, the median value of the fractal dimension of the positive electrode active material is smaller than or equal to 1.143. Alternatively, the median value of the circularity of the positive electrode active material is larger than or equal to 0.7.

### TECHNICAL FIELD

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a secondary battery, a power storage device, a memory device, an electronic device, or a manufacturing method thereof. One embodiment of the present invention relates to a vehicle including a semiconductor device, a display device, a light-emitting device, a secondary battery, a power storage device, or a memory device, or an electronic device for vehicles provided in a vehicle.

Note that electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1 to Patent Document 3). Crystal structures of positive electrode active materials have also been studied (Non-Patent Document 1 to Non-Patent Document 3).

X-ray diffraction (XRD) is one of methods used for analysis of a crystal structure of a positive electrode active material. With the use of the ICSD (Inorganic Crystal Structure Database) described in Non-Patent Document 4, XRD data can be analyzed.

### REFERENCES

### Patent Documents

[Patent Document 1] Japanese Published patent application No. H8-236114
[Patent Document 2] Japanese Published patent application No. 2002-124262
[Patent Document 3] Japanese Published patent application No. 2002-358953

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiXCoO₂ (0.0≤x≤1.0)”, Physical Review B, 80 (16); 165114.
[Non-Patent Document 3] Zhaohui Chen et al., “Staging Phase Transitions in LiXCoO₂”, Journal of The Electrochemical Society, 2002, 149 (12), A1604-A1609.
[Non-Patent Document 4] Belsky, A. et al., “New developments in the Inorganic Crystal Structure Database (ICSD): accessibility in support of materials research and design”, Acta Cryst., (2002) B58, 364-369.

### SUMMARY OF THE INVENTION

### Problems to be Solved by the Invention

However, development of lithium-ion secondary batteries and positive electrode active materials used therein has room for improvement in terms of charge and discharge capacity, cycle performance, reliability, safety, cost, and the like.

In forming a positive electrode of a lithium-ion secondary battery, for example, pressure is generally applied to a positive electrode active material layer and a positive electrode current collector. This produces effects of increasing the density of the positive electrode active material layer and adhering the positive electrode current collector and the positive electrode active material layer closely to each other. However, the pressure application sometimes causes breakage of a positive electrode active material.

In addition, repeated charging and discharging of a secondary battery sometimes cause cracking, breakage, and the like of a positive electrode active material.

The breakage or cracking of a positive electrode active material is likely to cause dissolution of a transition metal, an excessive side reaction, and the like and thus is not preferable in terms of charge and discharge capacity, cycle performance, reliability, safety, and the like.

In view of the above, an object of one embodiment of the present invention is to provide a positive electrode active material that is hardly broken when used in a lithium-ion battery even after being subjected to pressure application or charging and discharging. Another object is to provide a positive electrode active material with which a decrease in charge and discharge capacity in charge and discharge cycles is inhibited. Another object is to provide a positive electrode active material having a crystal structure that is unlikely to be broken by repeated charging and discharging. Another object is to provide a positive electrode active material with high charge and discharge capacity. Another object is to provide a highly safe or highly reliable secondary battery.

Another object of one embodiment of the present invention is to provide a novel material, novel active material particles, a novel power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

### Means for Solving the Problems

In order to achieve the above objects, the shape of a positive electrode active material is focused on in one embodiment of the present invention. With a crack, unevenness, a step, roughness, or the like on the surface of a positive electrode active material, stress tends to be concentrated on part, which easily causes breakage. By contrast, with a smooth surface and a nearly spherical shape, stress concentration is alleviated; thus, a positive electrode active material is hardly broken by pressure application and through charging and discharging. Therefore, a positive electrode active material with a smooth surface and little unevenness is formed.

One embodiment of the present invention is a positive electrode active material containing lithium and a transition metal, in which a median value of solidity is larger than or equal to 0.96.

Another embodiment of the present invention is a positive electrode active material containing lithium and a transition metal, in which a difference between a first quartile and a third quartile of solidity is less than or equal to 0.04.

Another embodiment of the present invention is a positive electrode active material containing lithium and a transition metal, in which a median value of fractal dimension is smaller than or equal to 1.143.

Another embodiment of the present invention is a positive electrode active material containing lithium and a transition metal, in which a median value of circularity is larger than or equal to 0.7.

In the above, the positive electrode active material preferably contains halogen.

In the above, halogen is further preferably fluorine.

In the above, the positive electrode active material preferably contains magnesium.

In the above, the positive electrode active material preferably contains nickel and aluminum.

Another embodiment of the present invention is a secondary battery including the positive electrode active material described above.

Another embodiment of the present invention is an electronic device including the secondary battery described above and any one of a circuit board, a sensor, and a display device.

### Effect of the Invention

According to one embodiment of the present invention, a positive electrode active material that is hardly broken when used in a lithium-ion secondary battery even after being subjected to pressure application or charging and discharging can be provided. Alternatively, a positive electrode active material with which a decrease in charge and discharge capacity in charge and discharge cycles is inhibited can be provided. Alternatively, a positive electrode active material having a crystal structure that is unlikely to be broken by repeated charging and discharging can be provided. Alternatively, a positive electrode active material with high charge and discharge capacity can be provided. Alternatively, a highly safe or highly reliable secondary battery can be provided.

According to one embodiment of the present invention, a novel material, novel active material particles, a novel power storage device, or a formation method thereof can be provided.

Note that the description of these effects does not preclude the existence of other effects. One embodiment of the present invention does not need to have all the effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A is a cross-sectional view of a positive electrode active material, and FIG. 1B1 and FIG. 1B2 are cross-sectional views of part of the positive electrode active material.

FIG. 2A1 to FIG. 2C2 are cross-sectional views of part of a positive electrode active material.

FIG. 3 is a cross-sectional view of a positive electrode active material of a comparative example.

FIG. 4A1 to FIG. 4B2 each illustrate a calculation model of lithium cobalt oxide.

FIG. 5A to FIG. 5C each illustrate a calculation model of lithium cobalt oxide.

FIG. 6 is a graph showing calculation results of energy in the case where fluorine is substituted for part of oxygen in lithium cobalt oxide.

FIG. 7 is a diagram illustrating the charge depth and crystal structures of a positive electrode active material.

FIG. 8 is a diagram showing XRD patterns calculated from crystal structures.

FIG. 9 is a diagram illustrating the charge depth and crystal structures of a positive electrode active material of a comparative example.

FIG. 10 is a diagram showing XRD patterns calculated from crystal structures.

FIG. 11A to FIG. 1C show lattice constants calculated from XRD.

FIG. 12A to FIG. 12C show lattice constants calculated from XRD.

FIG. 13 is a diagram showing a method for forming a positive electrode active material.

FIG. 14 is a diagram showing a method for forming a positive electrode active material.

FIG. 15 is a diagram showing a method for forming a positive electrode active material.

FIG. 16 is a diagram showing a method for forming a positive electrode active material.

FIG. 17A and FIG. 17B are cross-sectional views of an active material layer containing a graphene compound as a conductive material.

FIG. 18A and FIG. 18B are diagrams illustrating examples of a secondary battery.

FIG. 19A to FIG. 19C are diagrams illustrating an example of a secondary battery.

FIG. 20A and FIG. 20B are diagrams illustrating an example of a secondary battery.

FIG. 21A and FIG. 21B are diagrams illustrating a coin-type secondary battery. FIG. 21C is a diagram illustrating a secondary battery.

FIG. 22A to FIG. 22D are diagrams illustrating a cylindrical secondary battery.

FIG. 23A and FIG. 23B are diagrams illustrating an example of a secondary battery.

FIG. 24A to FIG. 24D are diagrams illustrating an example of a secondary battery.

FIG. 25A to FIG. 25C are diagrams illustrating an example of a secondary battery.

FIG. 26A to FIG. 26C are diagrams illustrating an example of a secondary battery.

FIG. 27A to FIG. 27C are diagrams illustrating a laminated secondary battery.

FIG. 28A and FIG. 28B are diagrams illustrating a laminated secondary battery.

FIG. 29 is an external view of a secondary battery.

FIG. 30 is an external view of a secondary battery.

FIG. 31A to FIG. 31C are diagrams illustrating a method for forming a secondary battery.

FIG. 32A to FIG. 32G are diagrams illustrating examples of electronic devices.

FIG. 33A to FIG. 33C are diagrams illustrating examples of electronic devices.

FIG. 34 is a diagram illustrating examples of electronic devices.

FIG. 35A to FIG. 35C are diagrams illustrating examples of electronic devices.

FIG. 36A to FIG. 36C are diagrams illustrating examples of electronic devices.

FIG. 37A to FIG. 37C are diagrams illustrating examples of vehicles.

FIG. 38A to FIG. 38C are box and whisker plots showing circularity, solidity, and fractal dimension distribution of a positive electrode active material in Example 1.

FIG. 39A to FIG. 39C each show charge and discharge curves at 25° C. of a secondary battery using a positive electrode active material in Example 1.

FIG. 40A to FIG. 40C each show charge and discharge curves at 45° C. of a secondary battery using a positive electrode active material in Example 1.

FIG. 41A to FIG. 41C each show charge and discharge curves at 50° C. of a secondary battery using a positive electrode active material in Example 1.

### MODE FOR CARRYING OUT THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing a minus sign (−) in front of the number instead of placing a bar over the number.

In this specification and the like, uneven distribution refers to a state where a concentration of a certain element is different from that in other regions, and may be rephrased as segregation, precipitation, unevenness, deviation, high concentration, low concentration, or the like.

In this specification and the like, uniformity refers to a phenomenon in which, in a solid made of a plurality of elements (e.g., A, B, and C), a certain element (e.g., A) is distributed with similar features in specific regions. Note that it is acceptable for the specific regions to have substantially the same concentration of the element. For example, a difference in the concentration of the element between the specific regions can be 10% or less. Examples of the specific regions include a surface, an outermost surface layer, a surface portion, a projection, a depression, and an inner portion.

In this specification and the like, a region that is approximately 10 nm in depth from the surface toward the inner portion of a positive electrode active material is referred to as a surface portion. A plane generated by a split or a crack may also be referred to as a surface. A region in a deeper position than the surface portion of a positive electrode active material is referred to as an inner portion. Furthermore, a region that is 3 nm in depth from the surface toward the inner portion in the surface portion of a positive electrode active material is referred to as the outermost surface layer. A surface of a positive electrode active material refers to a surface of a composite oxide including a surface portion including the above-mentioned outermost surface layer, an inner portion, and the like. Therefore, the positive electrode active material does not include a carbonic acid, a hydroxy group, or the like which is chemically adsorbed after formation of the positive electrode active material. Furthermore, an electrolyte solution, a binder, a conductive material, and a compound originating from any of these that are attached to the positive electrode active material are not included either. Not all of the positive electrode active material need to be a region including a lithium site that contributes to charging and discharging.

In this specification and the like, a layered rock-salt crystal structure of a composite oxide containing lithium and a transition metal M refers to a crystal structure in which a rock-salt ion arrangement where cations and anions are alternately arranged is included and lithium and the transition metal M are regularly arranged to form a two-dimensional plane, so that lithium can diffuse two-dimensionally. Note that a defect such as a cation or anion vacancy may partly exist as long as two-dimensional diffusion of lithium ions is possible. In the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist partly.

In this specification and the like, a mixture refers to a plurality of materials mixed. Among mixtures, a mixture in which mutual diffusion of elements has occurred may be referred to as a composite. The composite may partly contain an unreacted material.

In this specification and the like, a theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all lithium that can be inserted and extracted is inserted is 0, and the charge depth obtained when all lithium that can be inserted and extracted and is contained in a positive electrode active material is extracted is 1.

In this specification and the like, for a positive electrode active material, extraction of lithium ions is called charging.

In general, a positive electrode active material having the layered rock-salt crystal structure has an unstable crystal structure when lithium between layers consisting of the transition metal M and oxygen decreases. For this reason, in a general secondary battery using lithium cobalt oxide, the charge depth, the charge voltage (in the case of a lithium counter electrode), and the charge capacity are limited to about 0.4, 4.3 V, and 160 mAh/g, respectively, in charging.

By contrast, a positive electrode active material with a charge depth of greater than or equal to 0.74 and less than or equal to 0.9, more specifically, a charge depth of greater than or equal to 0.8 and less than or equal to 0.83 is referred to as a high-voltage charged positive electrode active material. Thus, for example, LiCoO₂ charged to a charge capacity of 219.2 mAh/g is a high-voltage charged positive electrode active material. In addition, LiCoO₂ that is subjected to constant current charging in an environment at 25° C. and charge voltage of higher than or equal to 4.525 V and lower than or equal to 4.65 V (in the case of a lithium counter electrode), and then subjected to constant voltage charging until the current value becomes 0.01 C or approximately ⅕ to 1/100 of the current value at the time of the constant current charging is also referred to as a high-voltage charged positive electrode active material. Note that C is an abbreviation for Capacity rate, and 1 C refers to the current amount with which the charge and discharge capacity of a secondary battery is fully charged or fully discharged in an hour.

For a positive electrode active material, insertion of lithium ions is called discharging. A positive electrode active material with a charge depth of less than or equal to 0.06 or a positive electrode active material from which more than or equal to 90% of the charge capacity is discharged from a high-voltage charged state is referred to as a sufficiently discharged positive electrode active material. For example, LiCoO₂ with a charge capacity of 219.2 mAh/g is in a state of being charged with high voltage, and a positive electrode active material from which more than or equal to 197.3 mAh/g, which is 90% of the charge capacity, is discharged is a sufficiently discharged positive electrode active material. In addition, LiCoO₂ that is subjected to constant current discharging in an environment at 25° C. until the battery voltage becomes lower than or equal to 3 V (in the case of a lithium counter electrode) is also referred to as a sufficiently discharged positive electrode active material.

In this specification and the like, an example in which a lithium metal is used as a counter electrode in a secondary battery using a positive electrode and a positive electrode active material of one embodiment of the present invention is described in some cases; however, the secondary battery of one embodiment of the present invention is not limited to this example. Another material such as graphite or lithium titanate may be used as a negative electrode, for example. The properties of the positive electrode and the positive electrode active material of one embodiment of the present invention, such as a crystal structure unlikely to be broken by repeated charging and discharging and excellent cycle performance, are not affected by the material of the negative electrode. The secondary battery of one embodiment of the present invention using a lithium counter electrode is charged and discharged at a voltage higher than a general charge voltage of approximately 4.6 V in some cases; however, charging and discharging may be performed at a lower voltage. Charging and discharging at a lower voltage may lead to the cycle performance better than that described in this specification and the like.

### EMBODIMENT 1

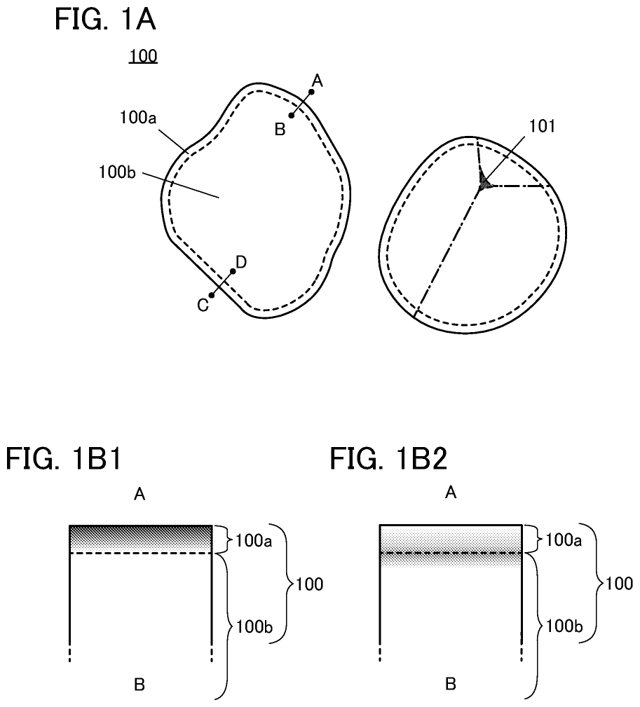

In this embodiment, a positive electrode active material of one embodiment of the present invention is described with reference to FIG. 1 to FIG. 12.

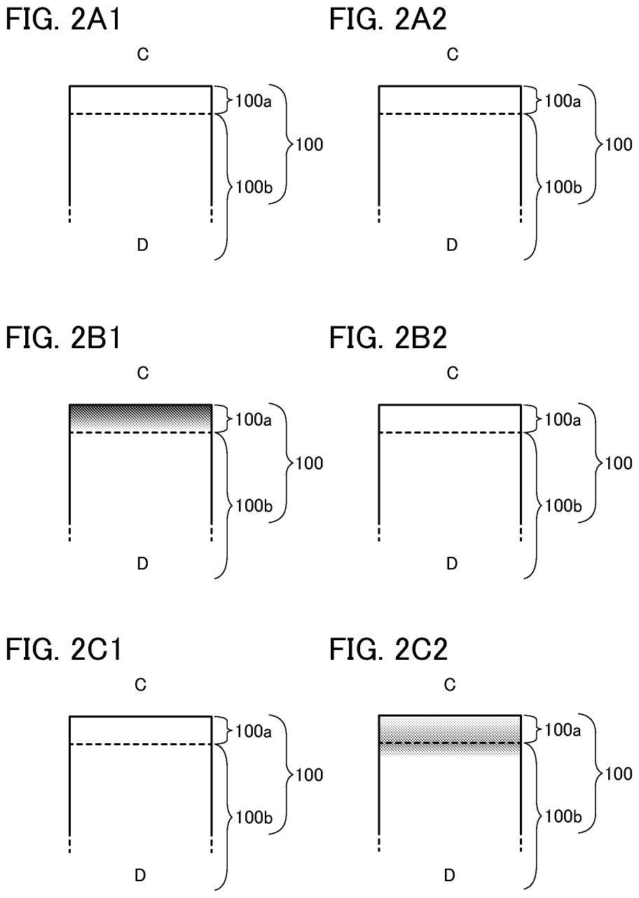

FIG. 1A is a cross-sectional view of a positive electrode active material 100 of one embodiment of the present invention. FIG. 1B1 and FIG. 1B2 show enlarged views of a portion near A-B in FIG. 1A. FIG. 2A1 to FIG. 2C2 show enlarged views of a portion near C-D in FIG. 1A.

As illustrated in FIG. 1A to FIG. 2C2, the positive electrode active material 100 includes a surface portion 100a and an inner portion 100b. In each drawing, the dashed line denotes a boundary between the surface portion 100a and the inner portion 100b. In FIG. 1A, the dashed-dotted line denotes part of a crystal grain boundary.

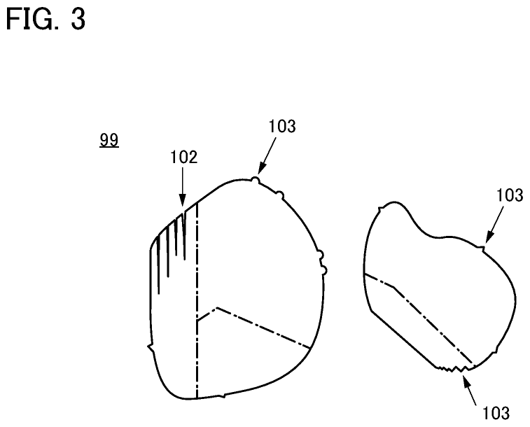

FIG. 3 is a cross-sectional view of a positive electrode active material 99 of a comparative example.

### <Particle Shape>

The shape of a particle of a positive electrode active material relates to cycle performance, charge and discharge capacity, reliability, safety, and the like. When the numbers of cracks 102, projections and depressions 103, and the like on the surface of a particle are large, as in the positive electrode active material 99 of a comparative example illustrated in FIG. 3, for example, stress is concentrated on a particular portion, which might easily cause the breakage, crack, and the like in a positive electrode active material. The breakage or crack in a positive electrode active material tends to cause dissolution of a transition metal M, an excessive side reaction, and the like. This is not preferable in terms of cycle performance, reliability, safety, and the like.

Thus, the positive electrode active material of one embodiment of the present invention preferably has a smooth surface, like the positive electrode active material 100 in FIG. 1A. A smooth surface alleviates the stress concentration, and the positive electrode active material is hardly broken by pressure application and through charging and discharging.

The surface smoothness of a positive electrode active material can be quantified by image analysis on a microscope image of a particle of a positive electrode active material, for example.

As a microscope image, for example, a surface SEM image, a cross-sectional SEM image, across-sectional TEM image, and the like can be used. Note that the shape of a positive electrode active material extracted from a surface SEM image may be the same as that of one of cross sections perpendicular to a SEM electron beam. Thus, quantitative values obtained from a surface SEM image may be used for analysis of a cross-sectional SEM image and a cross-sectional TEM image. Similarly, quantitative values obtained from a cross-sectional SEM image and a cross-sectional TEM image may be used for analysis of a surface SEM image.

When a microscope image of a positive electrode active material is captured, image capturing is preferably performed under the conditions where a positive electrode active material does not overlap with other particles and one particle fits in one field of view. In addition, image capturing is preferably performed under the observation conditions with a strong contrast between a particle and a background. Image capturing under such conditions makes the outline of a positive electrode active material clear and facilitates automatic extraction of a shape with the use of image analysis software. Thus, image analysis is easily performed. Note that one embodiment of the present invention is not limited thereto, and quantification can be performed when the shape of a positive electrode active material can be clearly extracted. For example, in the case of the conditions where another particle, a conductive material, a binder, or the like exists behind a positive electrode active material, a shape may be extracted manually or automatically and manually for clearly extracting a shape.

In order to obtain a significant difference statistically, microscope images of 10 or more particles are preferably obtained randomly.

As image analysis software, ImageJ can be used, for example. A two-dimensional shape can be extracted from a microscope image with the use of ImageJ. In addition, the area of an extracted two-dimensional shape of a particle can be calculated. Furthermore, circularity, solidity, and the like can be calculated as shape descriptors. When an outline is extracted from a microscope image and a fractal box count is measured, the fractal dimension can be calculated.

The circularity is 4π×(area)/(perimeter)². The median value of the circularity of the positive electrode active material of one embodiment of the present invention is preferably larger than or equal to 0.70, further preferably larger than or equal to 0.75.

The solidity is (area)/(convex hull area). The solidity represents the degree of a depression of a shape. Note that the convex hull area is an area of a given region entirely surrounded by a convex outline. The median value of the solidity of the positive electrode active material of one embodiment of the present invention is preferably larger than or equal to 0.96, further preferably larger than or equal to 0.97. A difference between the first quartile and the third quartile of the solidity is preferably less than or equal to 0.04, further preferably less than or equal to 0.03.

The fractal dimension represents the complexity of an outline. In a box counting method, when an outline of an object is regarded as a one-pixel-wide binary (black on white) boundary, the number of boxes required for covering the boundary is measured with varying box sizes. The size and number of boxes covering the outline are plotted on a log-log graph, and the fractal dimension can be calculated from the slope. The fractal dimension D_{boxcount} is equal to −(slope). The median value of the fractal dimension of the positive electrode active material of one embodiment of the present invention obtained by a box counting method is preferably smaller than or equal to 1.143, further preferably smaller than or equal to 1.141.

A positive electrode active material within the above ranges can be regarded as having a smooth surface. Note that a positive electrode active material does not necessarily satisfy the preferred ranges of all the parameters. A positive electrode active material having at least one of the above parameters within the preferred ranges can be regarded as having a sufficiently smooth surface.

### <Flux Effect>

The above-described positive electrode active material having a smooth surface is preferably formed in such a manner that a composite oxide containing lithium and the transition metal M and a material serving as a flux are mixed, and then the mixture is heated, for example. It is further preferable that, in addition to the material serving as a flux, an additive that contributes to the stabilization of a crystal structure be mixed, and then the mixture be heated.

Even the composite oxide that contains lithium and the transition metal M and has an insufficiently smooth surface can sometimes be a composite oxide whose surface is partly melted to be smooth when being heated at a temperature higher than or equal to the melting point of the composite oxide. However, heating at such a high temperature might have adverse effects such as decomposition of part of the composite oxide and the breakage of the crystal structure. When part of the composite oxide is decomposed or the crystal structure is broken, the charge and discharge capacity and the cycle performance would deteriorate.

In view of the above, the material serving as a flux and the composite oxide containing lithium and the transition metal M are mixed, so that their melting points can be lowered owing to a flux effect. Mixing the additive that contributes to the stabilization of a crystal structure may further lower the melting points. Thus, the surface of the composite oxide can be melted at a lower temperature than the melting point of the composite oxide. Hence, a positive electrode active material can have a smooth surface while the decomposition, the breakage of a crystal structure, and the like are inhibited. This makes it possible to provide a positive electrode active material that is excellent in charge and discharge capacity and cycle performance and has high reliability and a high level of safety.

As the material serving as a flux, a material having a lower melting point than the composite oxide containing lithium and the transition metal M is preferably used. A halide, halogen, or an alkali metal compound is preferably used. The material serving as a flux is preferably a solid or liquid at room temperature for easy mixing, but may be a gas at room temperature. In the case of a gas, a gas may be mixed into an atmosphere in a heating step.

As a halide and halogen, for example, lithium fluoride (LiF), calcium fluoride (CaF₂), sodium fluoride (NaF), potassium fluoride (KF), barium fluoride (BaF₂), sodium aluminum hexafluoride (Na₃AlF₆), lithium chloride (LiCl), magnesium chloride (MgCl₂), sodium chloride (NaCl), fluorine (F₂), chlorine (Cl₂), carbon fluoride (CF₄, CHF₃, CH₂F₂, or CH₃F), carbon chloride (CCl₄, CHCl₃, CH₂Cl₂, or CH₃Cl), sulfur fluoride (S₂F₂, SF₄, SF₆, or S₂F₁₀), sulfur chloride (SCl₂ or S₂Cl₂), oxygen fluoride (OF₂, O₂F₂, O₃F₂, O₄F₂, or O₂F), oxygen chloride (ClO₂), or the like can be used. Among them, lithium fluoride is preferable as the material serving as a flux because it is easily melted in a heating step owing to its relatively low melting point of 848° C.

As an alkali metal compound, lithium carbonate (Li₂CO₃), lithium hydroxide (LiOH or LiOH.H₂O), lithium oxide (Li₂O), lithium nitrate (LiNO₃), sodium carbonate (Na₂CO₃), sodium hydroxide (NaOH), sodium oxide (Na₂O), sodium nitrate (NaNO₃), or the like can be used.

Hydrate of any of the above-described materials may be used. A plurality of materials may be mixed to be used.

As the additive that contributes to the stabilization of a crystal structure, for example, a magnesium compound such as magnesium fluoride, magnesium hydroxide, or magnesium oxide; an aluminum compound such as aluminum fluoride, aluminum hydroxide, or aluminum oxide; a titanium compound such as titanium fluoride, titanium hydroxide, titanium oxide, or titanium nitride; a nickel compound such as nickel fluoride, nickel hydroxide, or nickel oxide; a zirconium compound such as zirconium fluoride or zirconium oxide; a vanadium compound such as vanadium fluoride; an iron compound such as iron fluoride or iron oxide; a chromium compound such as chromium fluoride or chromium oxide; a niobium compound such as niobium fluoride or niobium oxide; a cobalt compound such as cobalt fluoride or cobalt oxide; an arsenic compound such as arsenic oxide; a zinc compound such as zinc fluoride or zinc oxide; a cerium compound such as cerium fluoride or cerium oxide; a lanthanum compound such as lanthanum fluoride or lanthanum oxide; a silicon compound such as silicon oxide; sulfur and a sulfur compound; phosphorus and a phosphorus compound such as a phosphoric acid; a boron compound such as a boric acid; a manganese compound such as manganese fluoride or manganese oxide; or the like can be used.

Hydrate of any of the above-described materials may be used. A plurality of materials may be mixed to be used. Note that in this specification and the like, the additive may be referred to as “mixture”, “constituent of material”, “impurity”, or the like.

Note that the material serving as a flux and the additive that contributes to the stabilization of a crystal structure cannot be distinguished clearly from each other in some cases. A material may have both functions of a flux and stabilizing a crystal structure. Thus, any of the materials listed above as the additive that contributes to the stabilization of a crystal structure may be used as the material serving as a flux. In addition, any of the materials listed above as the material serving as a flux may be used as the additive that contributes to the stabilization of a crystal structure.

As the composite oxide containing lithium and the transition metal M, for example, a material having a layered rock-salt crystal structure, a spinel crystal structure, or an olivine crystal structure can be used. For example, the composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, lithium nickel-manganese-cobalt oxide, lithium iron phosphate, lithium ferrate, or lithium manganese oxide, can be used. Lithium is not necessarily contained as long as the material functions as a positive electrode active material, and V₂O₅, Cr₂O₅, MnO₂, or the like may be used.

### <Element Distribution>

When the material serving as a flux and the composite oxide containing lithium and the transition metal M are mixed and then heated as described above, part of an element included in the material serving as a flux is unevenly distributed in the surface portion of a positive electrode active material. In the case where an additive element that contributes to the stabilization of a crystal structure is also mixed and heated, part of the additive element is also unevenly distributed in the surface portion of a positive electrode active material.

Thus, the positive electrode active material 100 contains lithium, the transition metal M, oxygen, and an element included in the material serving as a flux. The additive element that contributes to the stabilization of a crystal structure is preferably also contained.

Examples of the transition metal M contained in the positive electrode active material 100 include cobalt, nickel, manganese, iron, vanadium, and chromium. In particular, a metal that can form, together with lithium, a layered rock-salt composite oxide belonging to the space group R-3m is preferably used. For example, at least one of manganese, cobalt, and nickel is preferably used. That is, as the transition metal M contained in the positive electrode active material 100, cobalt may be used alone, nickel may be used alone, cobalt and manganese may be used, cobalt and nickel may be used, or cobalt, manganese, and nickel may be used. In other words, the positive electrode active material 100 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide. Nickel is preferably contained as the transition metal M in addition to cobalt, in which case a crystal structure may be more stable in a high-voltage charged state. In the case where two sources, a cobalt source and a nickel source, are used, the atomic ratio of cobalt to nickel Co:Ni is preferably (1−x):x (0.3<x<0.75), further preferably (1−x):x (0.4≤x≤0.6). A secondary battery using a positive electrode active material with such an atomic ratio exhibits excellent cycle performance even in an environment at 50° C., for example, which is higher than room temperature.

Examples of the element included in the material serving as a flux include, as described above, halogen such as fluorine and chlorine, lithium, calcium, sodium, potassium, barium, aluminum, carbon, sulfur, and nitrogen.

As the additive element that contributes to the stabilization of a crystal structure, at least one of magnesium, aluminum, titanium, nickel, zirconium, vanadium, iron, chromium, niobium, cobalt, arsenic, zinc, cerium, lanthanum, silicon, sulfur, phosphorus, boron, and manganese is preferably used, as described above. Such elements further stabilize a crystal structure included in the positive electrode active material 100 in some cases, as described later.

The positive electrode active material 100 can contain lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like.

Note that manganese is not necessarily contained as the transition metal M. In addition, nickel is not necessarily contained. Moreover, iron, vanadium, or chromium is not necessarily contained.

Note that as the element included in the material serving as a flux, halogen such as fluorine and chlorine, lithium, magnesium, sodium, potassium, barium, aluminum, carbon, sulfur, or nitrogen is not necessarily contained.

As the additive element that contributes to the stabilization of a crystal structure, magnesium, aluminum, titanium, nickel, zirconium, vanadium, iron, chromium, niobium, cobalt, arsenic, zinc, cerium, lanthanum, silicon, sulfur, phosphorus, boron, or manganese is not necessarily contained.

Part of the element included in the material serving as a flux and part of the additive element are preferably distributed as illustrated by gradation in FIG. 1B1 and FIG. 1B2.

For example, an element X preferably has a concentration gradient as illustrated by gradation in FIG. 1B1, in which the concentration increases from the inner portion 100b toward the surface. Examples of the element X that preferably has such a concentration gradient include magnesium, halogen such as fluorine or chlorine, titanium, silicon, phosphorus, boron, and calcium.

Another element Y preferably has a concentration gradient as illustrated by gradation in FIG. 1B2 and exhibits a concentration peak at a deeper region than the concentration peak in FIG. 1B1. The concentration peak may be located in the surface portion or located deeper than the surface portion. For example, the peak is preferably located in a region that is 5 nm to 30 nm inclusive in depth from the surface. Examples of the element Y that preferably has such a concentration gradient include aluminum and manganese.

In order to prevent breakage of a layered structure formed of octahedrons of the transition metal M and oxygen even when lithium is extracted from the positive electrode active material 100 of one embodiment of the present invention owing to charging, the surface portion 100a having a high additive concentration, i.e., the outer portion of the particle, of the positive electrode active material 100 is reinforced.

The concentration gradient of the additive preferably exists uniformly in the surface portion 100a of the positive electrode active material 100. When the surface portion 100a partly has reinforcement, stress might be concentrated on parts that do not have reinforcement. The concentration of stress on part of a particle might cause defects such as cracks from that part, leading to breakage of the positive electrode active material and a decrease in charge and discharge capacity.

Note that all the additives do not necessarily have similar concentration gradients throughout the surface portion 100a of the positive electrode active material 100. FIG. 2A1, FIG. 2B1, and FIG. 2C1 illustrate examples of distribution of the element X in the vicinity of C-D in FIG. 1A. FIG. 2A2, FIG. 2B2, and FIG. 2C2 illustrate examples of distribution of the element Y in the vicinity of C-D.

For example, as illustrated in FIG. 2A1 and FIG. 2A2, there may be a region where neither the element X nor the element Y exists. As illustrated in FIG. 2B1 and FIG. 2B2, there may be a region where the element X exists but the element Y does not exist. As illustrated in FIG. 2C1 and FIG. 2C2, there may be a region where the element X does not exist but the element Y exists. The element Y in FIG. 2C2 preferably has a peak in a region that is not in the outermost surface layer in a manner similar to that of FIG. 1B2, and preferably has a peak in a region that is 3 nm to 30 nm from the surface, for example.

Magnesium, which is an example of the element X, is divalent and is more stable in lithium sites than in transition metal M sites in the layered rock-salt crystal structure; thus, magnesium is likely to enter the lithium sites. An appropriate concentration of magnesium in the lithium sites of the surface portion 100a facilitates maintenance of the layered rock-salt crystal structure. An appropriate concentration of magnesium does not have an adverse effect on insertion or extraction of lithium in charging and discharging, and is thus preferable. However, excess magnesium might adversely affect insertion and extraction of lithium.

Aluminum, which is an example of the element Y, is trivalent and has a high bonding strength with oxygen. Thus, when aluminum is contained as an additive and aluminum enters the lithium sites, a change in the crystal structure can be inhibited. Hence, the positive electrode active material 100 can have the crystal structure that is unlikely to be broken by repeated charging and discharging.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a charge and discharge capacity decrease due to repeated charging and discharging.

An internal short circuit of a secondary battery might cause not only malfunction in charging operation and discharging operation of the secondary battery but also heat generation and firing. In order to obtain a safe secondary battery, it is preferable that an internal short circuit not occur even at a high charge voltage. In the positive electrode active material 100 of one embodiment of the present invention, an internal short circuit is unlikely to occur even at a high charge voltage. Thus, a secondary battery having high charge and discharge capacity and a high level of safety can be obtained.

It is preferable that a secondary battery using the positive electrode active material 100 of one embodiment of the present invention have high charge and discharge capacity, excellent charge and discharge cycle performance, and safety simultaneously.

The concentration gradients of part of the element included in the material serving as a flux and part of the additive element that contributes to the stabilization of a crystal structure can be evaluated using energy dispersive X-ray spectroscopy (EDX), EPMA (electron probe microanalysis), or the like. In the EDX measurement and the EPMA measurement, the measurement in which a region is measured while scanning the region and evaluated two-dimensionally is referred to as surface analysis in some cases. In addition, to extract data of a linear region from surface analysis and evaluate the atomic concentration distribution in a positive electrode active material particle is referred to as linear analysis in some cases.

By EDX or EPMA surface analysis (e.g., element mapping), the concentrations of the additives in the surface portion 100a, the inner portion 100b, the vicinity of the crystal grain boundary, and the like of the positive electrode active material 100 can be quantitatively analyzed. By EDX or EPMA line analysis, peaks of the element concentrations can be analyzed.

When the positive electrode active material 100 is subjected to the line analysis, a peak of the magnesium concentration in the surface portion 100a is preferably exhibited by a region that is 3 nm in depth, further preferably 1 nm in depth, still further preferably 0.5 nm in depth from the surface toward the center of the positive electrode active material 100.

In addition, the distribution of fluorine contained in the positive electrode active material 100 preferably overlaps with the distribution of magnesium. Thus, in the line analysis, a peak of the fluorine concentration in the surface portion 100a is preferably exhibited by a region that is 3 nm in depth, further preferably 1 nm in depth, still further preferably 0.5 nm in depth from the surface toward the center of the positive electrode active material 100.

In the case where the positive electrode active material 100 contains aluminum, the peak of the magnesium concentration is preferably closer to the surface than the peak of the aluminum concentration is in the surface portion 100a in the line analysis. For example, the peak of the aluminum concentration is preferably located at a depth of greater than or equal to 0.5 nm and less than or equal to 50 nm, further preferably greater than or equal to 5 nm and less than or equal to 30 nm from the surface toward the center of the positive electrode active material 100. Alternatively, the peak of the aluminum concentration is preferably located at a depth of greater than or equal to 0.5 nm and less than or equal to 30 nm. Further alternatively, the peak of the aluminum concentration is preferably located at a depth of greater than or equal to 5 nm and less than or equal to 50 nm.

According to results of the EDX or EPMA line analysis, where a surface of the positive electrode active material 100 is can be estimated as follows. A point where the detected amount of an element that uniformly exists in the inner portion 100b of the positive electrode active material 100, e.g., oxygen or the transition metal M such as cobalt, is ½ of the detected amount thereof in the inner portion is assumed as the surface.

Since the positive electrode active material 100 is a composite oxide, the detected amount of oxygen is preferably used to estimate where the surface is. Specifically, an average value Oₐᵥₑ of the oxygen concentration of a region of the inner portion 100b where the detected amount of oxygen is stable is calculated first. At this time, in the case where oxygen O_{background} which is probably led from chemical adsorption or the background is detected outside the surface, O_{background} is subtracted from the measurement value to obtain the average value Oₐᵥₑ of the oxygen concentration. The measurement point where the measurement value which is closest to ½ of the average value Oₐᵥₑ, or ½Oₐᵥₑ, is obtained can be estimated to be the surface of the positive electrode active material.

Where the surface is can also be estimated with the use of the transition metal M contained in the positive electrode active material 100. For example, in the case where 95% or more of the transition metals M is cobalt, the detected amount of cobalt can be used to estimate where the surface is as in the above description. Alternatively, the sum of the detected amounts of the transition metals M can be used for the estimation in a similar manner. The detected amount of the transition metal M is unlikely to be affected by chemical adsorption and is thus suitable for the estimation of where the surface is.

For example, when the additive is magnesium and the transition metal M is cobalt, the atomic ratio of magnesium to cobalt (Mg/Co) is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the atomic ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

### <Uneven Distribution of Fluorine>

The case where the positive electrode active material 100 contains fluorine, which is one of the elements X each of which preferably has a concentration gradient as illustrated in FIG. 1B1 in which the concentration increases from the inner portion 100b toward the surface is considered; models of the surface portion and the inner portion are created to compare their energies.

The surface energy Eₛ can be calculated by Formula (1) below.

$$\begin{matrix}[ Formula 1 ] & \\ {E}_{s} = \frac{( {E}_{s u r f} - {E}_{b u l k} )}{S} & ( 1 )\end{matrix}$$

In Formula (1), E_{surf} represents the total energy of the surface model, E_{bulk} represents the total energy of the bulk model, and S represents the surface area. According to this formula, it is found that the surface energy is smaller as the surface is stable more.

The description is made below on the assumption that the composite oxide containing lithium and the transition metal M is lithium cobalt oxide (LiCoO₂). First, in order to examine which crystal plane of LiCoO₂ of the space group R-3m that does not contain F tends to appear in the surface, the (100) plane, the (102) plane, the (1-20) plane, the (104) plane, and the (001) plane are selected, and the surface energy of each plane is calculated. The calculation conditions are listed in Table 1.

TABLE 1

| Software | VASP | |
|---|---|---|
| Functional | GGA + U (DFT-D2) | |
| Pseudo potential | PAW | |
| Cutoff energy (eV) | 600 | |
| U potential | Co | 4.91 |

| | |
|---|---|
| Number of atoms | 96 Li atoms, 96 Co atoms, and |
| | 192 O atoms |
| k-points | 1 × 1 × 1 |

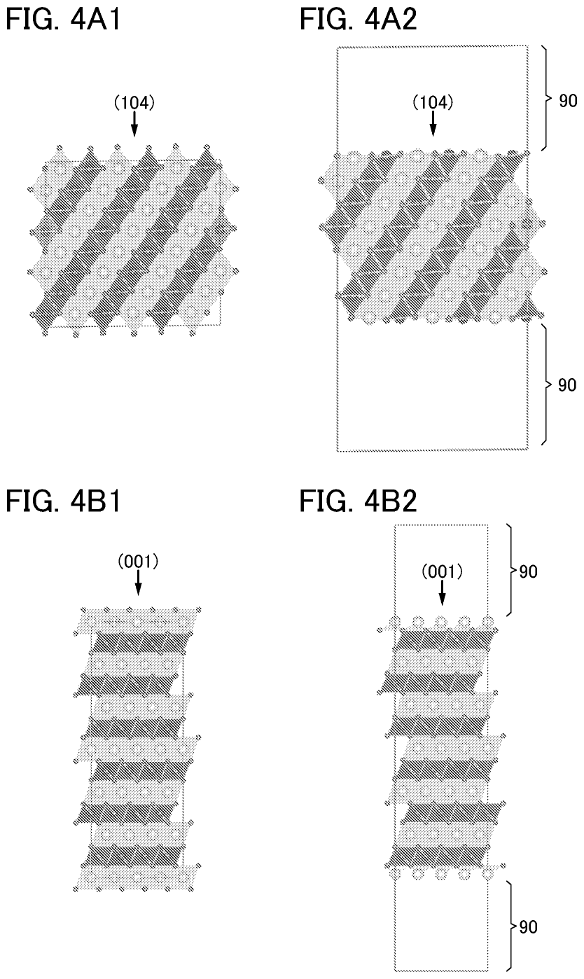

FIG. 4A1 to FIG. 4B2 illustrate examples of calculation models. FIG. 4A1 illustrates a bulk, i.e., an internal model, and the (104) plane exists perpendicular to an arrow in the figure. FIG. 4A2 illustrates a region including a surface, i.e., a surface portion model, and the (104) plane is exposed at the surface. FIG. 4B1 illustrates an internal model, and the (001) plane exists perpendicular to an arrow in the figure. FIG. 4B2 illustrates a surface portion model, and the (001) plane is exposed at the surface. The surface portion model is created by providing vacuum regions 90 with a total of 20 Å in the plane direction of the bulk model.

Table 2 shows the calculation results of the surface energy of each cut plane.

TABLE 2
Calculated surface energy (without F element)

| | Surface energy |
|---|---|
| Cut plane | [eV/Å²] |
| (100) | 0.343 |
| (102) | 0.242 |
| (1-20) | 0.241 |
| (104) | 0.146 |
| (001) | 0.204 |

Table 2 reveals that the (104) plane and the (001) plane tend to have small surface energies. These planes are stabilized and thus are easily exposed at the surface.

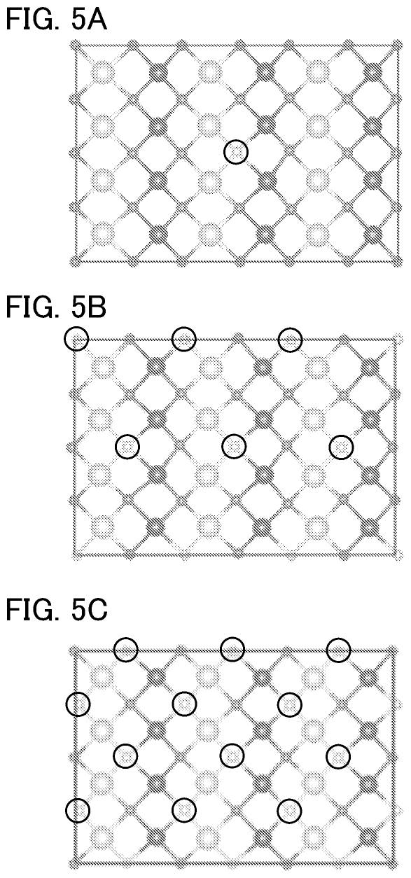

Next, the surface energy of the (104) plane with the smallest surface energy in the case where an F element exists is calculated. F elements are substituted for some of 24 O elements existing in one plane of the (104) plane. The substitution numbers are 1, 6, and 12. FIG. 5A, FIG. 5B, and FIG. 5C respectively illustrate a calculation model in which the substitution number is 1, a calculation model in which the substitution number is 6, and a calculation model in which the substitution number is 12. FIG. 5A to FIG. 5C illustrate the atomic arrangement of the (104) plane seen from a vertical direction. The positions for which F elements are substituted are surrounded by circles.

Table 3 lists the calculated surface energies of lithium cobalt oxide in the case where the F element is substituted for the O element.

TABLE 3
Calculated surface energy (with F element)

| Substitution number | |
|---|---|
| with F elements | Surface energy |
| (Substitution rate) | [eV/Å²] |
| 0 (0%) | 0.146 |
| 1 (4%) | 0.141 |
| 6 (25%) | 0.115 |
| 12 (50%) | 0.109 |

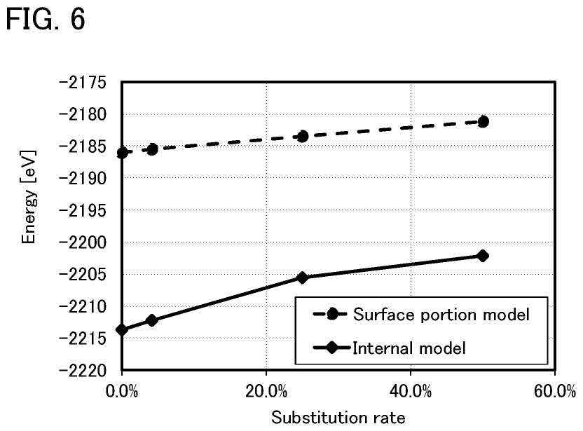

Table 3 reveals that the surface energy tends to be smaller as the substitution number with F elements increases. FIG. 6 is a graph showing plots of the total energies of the surface portion model and the internal model.

FIG. 6 shows that as the substitution number with F elements increases, the total energies of the surface portion model and the internal model become unstable. However, the instability rate is higher in the internal model; thus, the surface energy corresponding to the difference between the total energies becomes small. The results indicate that the F element is unstable when existing inside LiCoO₂ and is likely to be unevenly distributed in the surface.

Thus, a positive electrode active material in which fluorine is unevenly distributed in a surface portion can be regarded as a positive electrode active material in which sufficient mutual diffusion of elements has occurred through heating.

### <Crystal Structure>

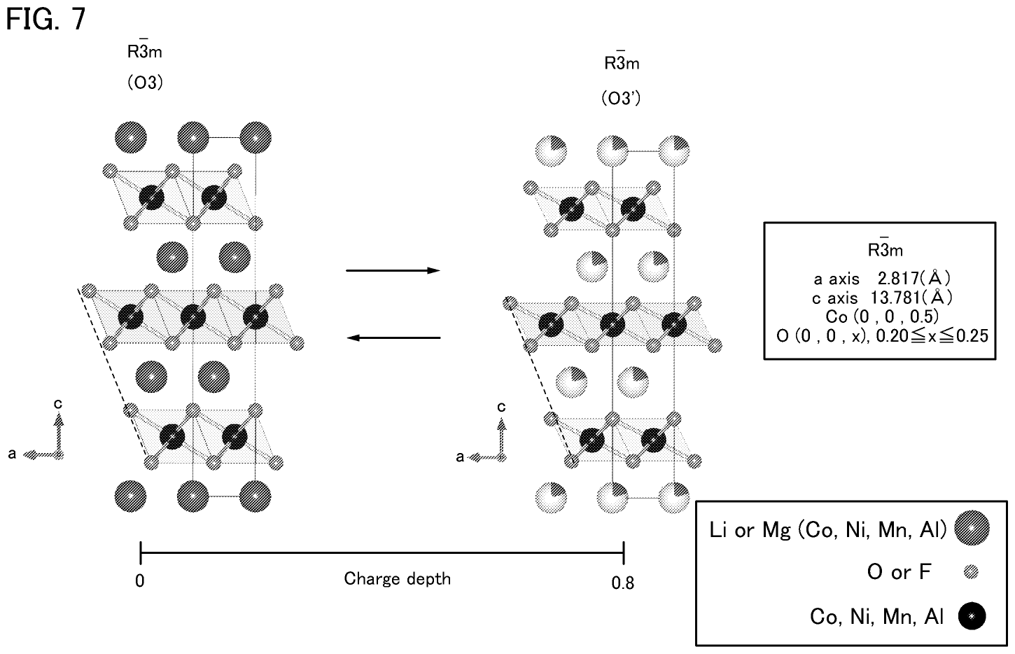

Crystal structures of the inner portion 100b of a positive electrode active material are described with reference to FIG. 7 to FIG. 12.

A material with a layered rock-salt crystal structure, such as lithium cobalt oxide (LiCoO₂), is known to have a high discharge capacity and excel as a positive electrode active material of a secondary battery. Examples of a material with a layered rock-salt crystal structure include a composite oxide represented by LiMO₂. Note that in this specification and the like, a lithium composite oxide represented by LiMO₂ needs to have a layered rock-salt crystal structure, and the composition is not strictly limited to Li:M:O=1:1:2. In FIG. 7 to FIG. 12, the case where cobalt is used as the transition metal M contained in the positive electrode active material is described.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with high voltage are performed on LiNiO₂, the crystal structure might be broken because of the distortion. The influence of the Jahn-Teller effect is suggested to be small in LiCoO₂; hence, LiCoO₂ is preferable because the tolerance at the time of high voltage charging is higher in some cases.

### <Conventional Positive Electrode Active Material>

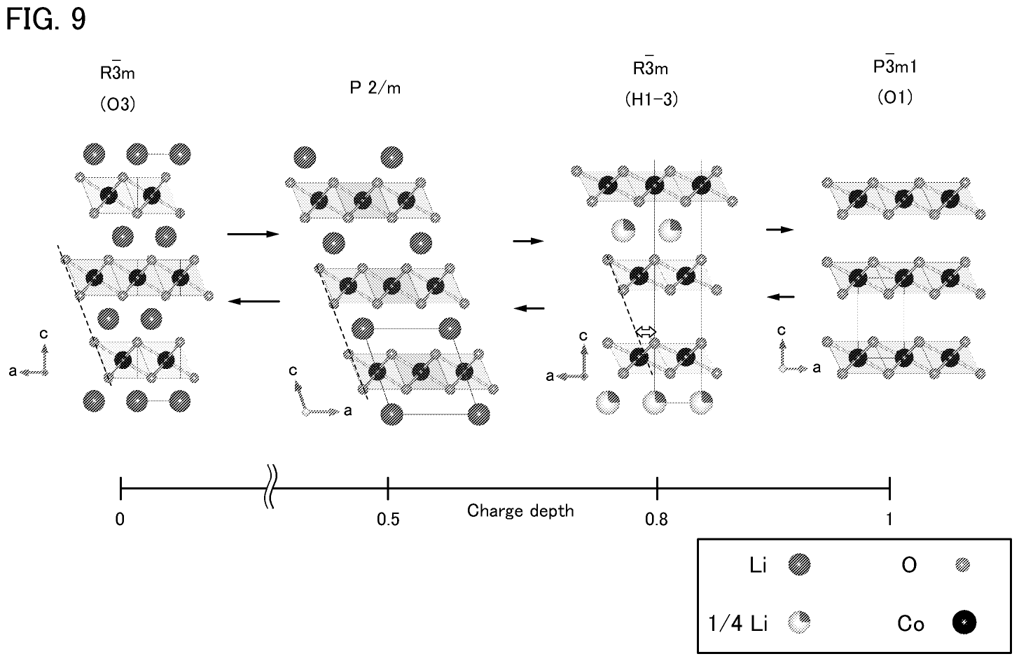

A positive electrode active material shown in FIG. 9 is lithium cobalt oxide (LiCoO₂) to which halogen and magnesium are not added in a formation method described later. As described in Non-Patent Document 1, Non-Patent Document 2, and the like, the crystal structure of the lithium cobalt oxide shown in FIG. 9 changes with the charge depth.

As shown in FIG. 9, lithium cobalt oxide with a charge depth of 0 (discharged state) includes a region having a crystal structure belonging to the space group R-3m, and includes three CoO₂ layers in a unit cell. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3 ml and includes one CoO₂ layer in a unit cell. Hence, this crystal structure is referred to as an O₁ type crystal structure in some cases.

Lithium cobalt oxide with a charge depth of approximately 0.8 has the crystal structure belonging to the space group R-3m. This structure can also be regarded as a structure in which CoO₂ structures such as a structure belonging to P-3 ml (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 9, and other drawings, the c-axis of the H1-3 type crystal structure is half that of the unit cell for easy comparison with the other structures.

For the H1-3 type crystal structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type crystal structure is represented by a unit cell including one cobalt atom and two oxygen atoms. Meanwhile, the O3′ type crystal structure of embodiments of the present invention are preferably represented by a unit cell including one cobalt atom and one oxygen atom, as described later. This means that the symmetry of cobalt and oxygen differs between the O3′ structure and the H1-3 type structure, and the amount of change from the O3 structure is smaller in the O3′ structure than in the H1-3 type structure. A preferred unit cell for representing a crystal structure in a positive electrode active material is selected such that the value of GOF (goodness of fit) is smaller in Rietveld analysis of XRD, for example.

When charging at a high charge voltage of 4.6 V or more with reference to the redox potential of a lithium metal or charging with a large charge depth of 0.8 or more and discharging are repeated, the crystal structure of lithium cobalt oxide changes (i.e., an unbalanced phase change occurs) repeatedly between the H1-3 type crystal structure and the structure belonging to R-3m (O3) in a discharged state.

However, there is a large shift in the CoO₂ layers between these two crystal structures. As denoted by the dotted lines and the arrow in FIG. 9, the CoO₂ layer in the H1-3 type crystal structure largely shifts from R-3m (O3). Such a dynamic structural change can adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are arranged continuously, such as P-3 ml (O1), included in the H1-3 type crystal structure is highly likely to be unstable.

Accordingly, the repeated charging and discharging with high voltage gradually break the crystal structure of lithium cobalt oxide. The broken crystal structure triggers deterioration of the cycle performance. This is because the broken crystal structure has a smaller number of sites where lithium can exist stably and makes it difficult to insert and extract lithium.

### <Positive Electrode Active Material of One Embodiment of the Present Invention>

### <<Inner Portion>>

In the positive electrode active material 100 of one embodiment of the present invention, the shift in CoO₂ layers can be small in repeated charging and discharging with high voltage. Furthermore, the change in the volume can be small. Accordingly, the positive electrode active material of one embodiment of the present invention can achieve excellent cycle performance. In addition, the positive electrode active material of one embodiment of the present invention can have a stable crystal structure in a high-voltage charged state. Thus, in the positive electrode active material of one embodiment of the present invention, a short circuit is unlikely to occur while the high-voltage charged state is maintained, in some cases. This is preferable because the safety is further improved.

The positive electrode active material of one embodiment of the present invention has a small crystal-structure change and a small volume difference per the same number of atoms of the transition metal between a sufficiently discharged state and a high-voltage charged state.

FIG. 7 shows a crystal structure of the positive electrode active material 100 before and after charging and discharging. The positive electrode active material 100 is a composite oxide containing lithium, cobalt as the transition metal M, and oxygen. In addition to the above-described elements, magnesium is preferably contained as the additive. Furthermore, halogen such as fluorine or chlorine is preferably contained as the additive.

The crystal structure with a charge depth of 0 (discharged state) in FIG. 7 is R-3m (O3), which is the same as in FIG. 9. Meanwhile, the positive electrode active material 100 with a charge depth in a sufficiently charged state includes a crystal whose structure is different from the H1-3 type crystal structure. This structure belongs to the space group R-3m and is not the spinel crystal structure but has symmetry in cation arrangement similar to that of the spinel structure because an ion of cobalt, magnesium, or the like occupies a site coordinated to six oxygen atoms. Furthermore, the symmetry of CoO₂ layers of this structure is the same as that in the O3 type structure. This structure is thus referred to as the O3′ type crystal structure or the pseudo-spinel crystal structure in this specification and the like. Accordingly, the O3′ type crystal structure may be rephrased as the pseudo-spinel crystal structure. Although a chance of the existence of lithium is the same in all lithium sites in FIG. 7, one embodiment of the present invention is not limited thereto. Lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example. In both the O3 type crystal structure and the O3′ type crystal structure, a slight amount of magnesium preferably exists between the CoO₂ layers, i.e., in lithium sites.

Note that in the O3′ type crystal structure, a light element such as lithium sometimes occupies a site coordinated to four oxygen atoms; also in this case, the ion arrangement has symmetry similar to that of the spinel structure.

The O3′ type crystal structure can be regarded as a crystal structure that contains Li between layers randomly and is similar to a CdCl₂ type crystal structure. The crystal structure similar to the CdCl₂ type crystal structure is close to a crystal structure of lithium nickel oxide charged to a charge depth of 0.94 (Li_{0.06}NiO₂); however, pure lithium cobalt oxide or a layered rock-salt positive electrode active material containing a large amount of cobalt is known not to have such a crystal structure generally.

Anions of a layered rock-salt crystal and anions of a rock-salt crystal form a cubic close-packed structure (face-centered cubic lattice structure). Anions of an O3′ crystal are presumed to form a cubic close-packed structure. When these crystals are in contact with each other, there exists a crystal plane at which orientations of cubic close-packed structures formed of anions are aligned with each other. Note that the space group of the layered rock-salt crystal and the O3′ crystal is R-3m, which is different from the space group Fm-3m (the space group of a general rock-salt crystal) and the space group Fd-3m (the space group having the simplest symmetry in rock-salt crystals) of rock-salt crystals; thus, the Miller index of the crystal plane satisfying the above conditions in the layered rock-salt crystal and the O3′ crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other.

The orientations of crystals in two regions being substantially aligned with each other can be judged, for example, from a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, or the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

In the positive electrode active material 100 of one embodiment of the present invention, a change in the crystal structure caused when a large amount of lithium is extracted by charging with high voltage is smaller than that in a conventional positive electrode active material. As denoted by the dotted lines in FIG. 7, for example, the CoO₂ layers hardly shift between the crystal structures.

Specifically, the structure of the positive electrode active material 100 of one embodiment of the present invention is highly stable even when charge voltage is high. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, the H1-3 type crystal structure is eventually observed in some cases. In the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V. In a higher charge voltage region, for example, at a voltage higher than or equal to 4.35 V and lower than or equal to 4.55 V with reference to the potential of a lithium metal, there is a region within which the O3′ type crystal structure can be obtained.

Thus, in the positive electrode active material 100 of one embodiment of the present invention, the crystal structure is unlikely to be broken even when charging and discharging with high voltage are repeated.

Note that in the unit cell of the O3′ type crystal structure, the coordinates of cobalt and oxygen can be represented by Co (0, 0, 0.5) and O (0, 0, x) within the range of 0.20≤x≤0.25.

A slight amount of the additive such as magnesium randomly existing between the CoO₂ layers, i.e., in lithium sites, can suppress a shift in the CoO₂ layers at the time of charging with high voltage. Thus, magnesium between the CoO₂ layers makes it easier to obtain the O3′ type crystal structure. Therefore, magnesium is preferably distributed throughout a particle of the positive electrode active material 100 of one embodiment of the present invention. To distribute magnesium throughout the particle, heat treatment is preferably performed in the formation process of the positive electrode active material 100 of one embodiment of the present invention.

However, heat treatment at an excessively high temperature may cause cation mixing, which increases the possibility of entry of the additive such as magnesium into the cobalt sites. Magnesium in the cobalt sites does not have the effect of maintaining the structure belonging to R-3m at the time of charging with high voltage. Furthermore, heat treatment at an excessively high temperature might have an adverse effect; for example, cobalt might be reduced to have a valence of two or lithium might be evaporated.

In view of the above, the material serving as a flux is preferably added to lithium cobalt oxide before the heat treatment for distributing magnesium throughout the particle. This decreases the melting point. The decreased melting point makes it easier to distribute magnesium throughout the particle at a temperature at which the cation mixing is unlikely to occur. Furthermore, fluorine contained in the material serving as a flux probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 and less than 0.04, still further preferably approximately 0.02 the number of atoms of the transition metal M. Alternatively, the number of magnesium atoms in the positive electrode active material of one embodiment of the present invention is preferably greater than or equal to 0.001 times and less than 0.04 or greater than or equal to 0.01 and less than or equal to 0.1 the number of atoms of the transition metal M. The magnesium concentration described here may be a value obtained by element analysis on the whole particles of the positive electrode active material using ICP-MS or the like, or may be a value based on the ratio of the raw materials mixed in the process of forming the positive electrode active material, for example.

As a metal other than cobalt (hereinafter, a metal Z), one or more metals selected from nickel, aluminum, manganese, titanium, vanadium, and chromium may be added to lithium cobalt oxide, for example, and in particular, at least one of nickel and aluminum is preferably added. In some cases, manganese, titanium, vanadium, and chromium are likely to have a valence of four stably and thus contribute highly to a stable structure. The addition of the metal Z may enable the positive electrode active material of one embodiment of the present invention to have a more stable crystal structure in the high-voltage charged state, for example. Here, in the positive electrode active material of one embodiment of the present invention, the metal Z is preferably added at a concentration that does not greatly change the crystallinity of the lithium cobalt oxide. For example, the metal Z is preferably added at an amount with which the aforementioned Jahn-Teller effect is not exhibited.

As shown in introductory remarks in FIG. 7, aluminum and the transition metal M typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the charge and discharge capacity of the positive electrode active material decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material of one embodiment of the present invention contains nickel as the metal Z in addition to magnesium, the charge and discharge capacity per weight and per volume can be increased in some cases. When the positive electrode active material of one embodiment of the present invention contains aluminum as the metal Z in addition to magnesium, the charge and discharge capacity per weight and per volume can be increased in some cases. When the positive electrode active material of one embodiment of the present invention contains nickel and aluminum in addition to magnesium, the charge and discharge capacity per weight and per volume can be increased in some cases.

The preferred concentrations of the elements contained in the positive electrode active material of one embodiment of the present invention, such as magnesium and the metal Z, are described below using the number of atoms.

The number of nickel atoms in the positive electrode active material of one embodiment of the present invention is preferably greater than 0% and less than or equal to 7.5%, further preferably greater than or equal to 0.05% and less than or equal to 4%, still further preferably greater than or equal to 0.1% and less than or equal to 2% of the number of cobalt atoms. Alternatively, the number of nickel atoms in the positive electrode active material of one embodiment of the present invention is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The nickel concentration described here may be a value obtained by element analysis on the whole particles of the positive electrode active material using ICP-MS or the like, or may be a value based on the ratio of the raw materials mixed in the process of forming the positive electrode active material, for example.

The number of aluminum atoms in the positive electrode active material of one embodiment of the present invention is preferably greater than or equal to 0.05% and less than or equal to 4%, further preferably greater than or equal to 0.1% and less than or equal to 2% of the number of cobalt atoms. Alternatively, the number of aluminum atoms in the positive electrode active material of one embodiment of the present invention is preferably greater than or equal to 0.05% and less than or equal to 2%, or greater than or equal to 0.1% and less than or equal to 4% of the number of cobalt atoms. The aluminum concentration described here may be a value obtained by element analysis on the whole particles of the positive electrode active material using ICP-MS or the like, or may be a value based on the ratio of the raw materials mixed in the process of forming the positive electrode active material, for example.

It is preferable that the positive electrode active material of one embodiment of the present invention contain an element Wand phosphorus be used as the element W. The positive electrode active material of one embodiment of the present invention further preferably includes a compound containing phosphorus and oxygen.

When the positive electrode active material of one embodiment of the present invention includes a compound containing the element W, a short circuit can be inhibited while a high-voltage charged state is maintained, in some cases.

When the positive electrode active material of one embodiment of the present invention contains phosphorus as the element W, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the charge solution may inhibit corrosion of a current collector or separation of a coating film or may inhibit a reduction in adhesion properties due to gelling or insolubilization of PVDF.

When containing magnesium in addition to the element W, the positive electrode active material of one embodiment of the present invention is extremely stable in a high-voltage charged state. When the element W is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to 0.5% and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the whole particles of the positive electrode active material using ICP-MS or the like, or may be a value based on the ratio of the raw materials mixed in the process of forming the positive electrode active material, for example.

In the case where the positive electrode active material has a crack, phosphorus, more specifically, a compound containing phosphorus and oxygen, in the inner portion of the crack may inhibit crack development, for example.

<<Surface Portion 100a>>

It is preferable that magnesium be distributed throughout a particle of the positive electrode active material 100 of one embodiment of the present invention, and it is further preferable that the magnesium concentration in the surface portion 100a be higher than the average magnesium concentration in the whole particle as illustrated in FIG. 1B1. For example, the magnesium concentration in the surface portion 100a measured by XPS or the like is preferably higher than the average magnesium concentration in the whole particles measured by ICP-MS or the like.

In the case where the positive electrode active material 100 of one embodiment of the present invention contains an element other than cobalt, for example, one or more metals selected from nickel, aluminum, manganese, iron, and chromium, the concentration of the metal in the surface portion of the particle is preferably higher than the average concentration of the metal in the whole particle. For example, the concentration of the element other than cobalt in the surface portion 100a measured by XPS or the like is preferably higher than the average concentration of the element in the whole particles measured by ICP-MS or the like.

The particle surface is in a state where bonds are cut unlike the crystal's inner portion, and lithium is extracted from the surface during charging; thus, the lithium concentration in the surface portion tends to be lower than that in the inner portion. Therefore, the surface portion tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The concentration of halogen such as fluorine in the surface portion 100a of the positive electrode active material 100 of one embodiment of the present invention is preferably higher than the average concentration in the whole particle as described above. When halogen exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the additives such as magnesium and fluorine are preferably higher than those in the inner portion. The surface portion 100a having such a composition preferably has a crystal structure stable at room temperature (25° C.). Accordingly, the surface portion 100a may have a crystal structure different from that of the inner portion 100b. For example, at least part of the surface portion 100a of the positive electrode active material 100 of one embodiment of the present invention may have a rock-salt crystal structure. When the surface portion 100a and the inner portion 100b have different crystal structures, the orientations of crystals in the surface portion 100a and the inner portion 100b are preferably substantially aligned with each other.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The element X is preferably positioned in the surface portion 100a of the particle of the positive electrode active material 100 of one embodiment of the present invention. For example, the positive electrode active material 100 of one embodiment of the present invention may be covered with the coating film containing the element X.

### <<Grain Boundary>>

A slight amount of magnesium or halogen contained in the positive electrode active material 100 of one embodiment of the present invention may randomly exist in the inner portion, but part of the element is further preferably segregated at a crystal grain boundary 101 as illustrated in FIG. 1A.

In other words, the magnesium concentration at the crystal grain boundary 101 and the vicinity thereof in the positive electrode active material 100 of one embodiment of the present invention is preferably higher than that in the other regions in the inner portion. In addition, the halogen concentration at the crystal grain boundary 101 and the vicinity thereof is preferably higher than that in the other regions in the inner portion.

The crystal grain boundary 101 is a plane defect, and thus tends to be unstable and suffer a change in the crystal structure like the particle surface. Thus, the higher the magnesium concentration at the crystal grain boundary 101 and the vicinity thereof is, the more effectively the change in the crystal structure can be reduced.

When the magnesium concentration and the halogen concentration are high at the crystal grain boundary and the vicinity thereof, the magnesium concentration and the halogen concentration in the vicinity of a surface generated by a crack are also high even when the crack is generated along the crystal grain boundary 101 of the particle of the positive electrode active material 100 of one embodiment of the present invention. Thus, the positive electrode active material including a crack can also have an increased corrosion resistance to hydrofluoric acid.

Note that in this specification and the like, the vicinity of the crystal grain boundary 101 refers to a region of approximately 10 nm from the grain boundary.

When the EDX or EPMA line analysis or the EDX or EPMA surface analysis is performed on the positive electrode active material 100, the ratio of an additive I to the transition metal M (I/M) in the vicinity of the crystal grain boundary is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, D50 is preferably greater than or equal to 1 μm and less than or equal to 40 μm, greater than or equal to 1 μm and less than or equal to 30 μm, greater than or equal to 2 μm and less than or equal to 100 μm, greater than or equal to 2 μm and less than or equal to 30 μm, greater than or equal to 5 μm and less than or equal to 100 μm, or greater than or equal to 5 μm and less than or equal to 40 μm.

### <Analysis Method>

Whether or not a positive electrode active material has the O3′ type crystal structure when charged with high voltage can be judged by analyzing a positive electrode charged with high voltage by XRD, electron diffraction, neutron diffraction, electron spin resonance (ESR), nuclear magnetic resonance (NMR), or the like. XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example.

A positive electrode active material having the O3′ type crystal structure when charged at high voltage has a feature in a small change in the crystal structure between a high-voltage charged state and a discharged state as described above. A material where 50 wt % or more of the crystal structure largely changes between the high-voltage charged state and the discharged state is not preferable because the material cannot withstand the high-voltage charging and discharging. It should be noted that the intended crystal structure is not obtained in some cases only by addition of the additive element. For example, in a high-voltage charged state, lithium cobalt oxide containing magnesium and fluorine has the O3′ type crystal structure at 60 wt % or more in some cases, and has the H1-3 type crystal structure at 50 wt % or more in other cases. This is influenced not only by the concentrations of the material serving as a flux, such as magnesium or fluorine, and the additive but also by whether through appropriate annealing temperature and annealing time. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD and other methods.

However, the crystal structure of a positive electrode active material in a high-voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charging Method>>

High-voltage charging for determining whether or not a composite oxide is the positive electrode active material having the O3′ type crystal structure when charged with high voltage can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive additive, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

Stainless steel (SUS) can be used for a positive electrode can and a negative electrode can.

The coin cell fabricated under the above conditions is subjected to constant current charging at 4.6 V and 0.5 C and then constant voltage charging until the current value reaches 0.01 C. Note that here, 1 C can be 137 mA/g. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere.

### <<XRD>>

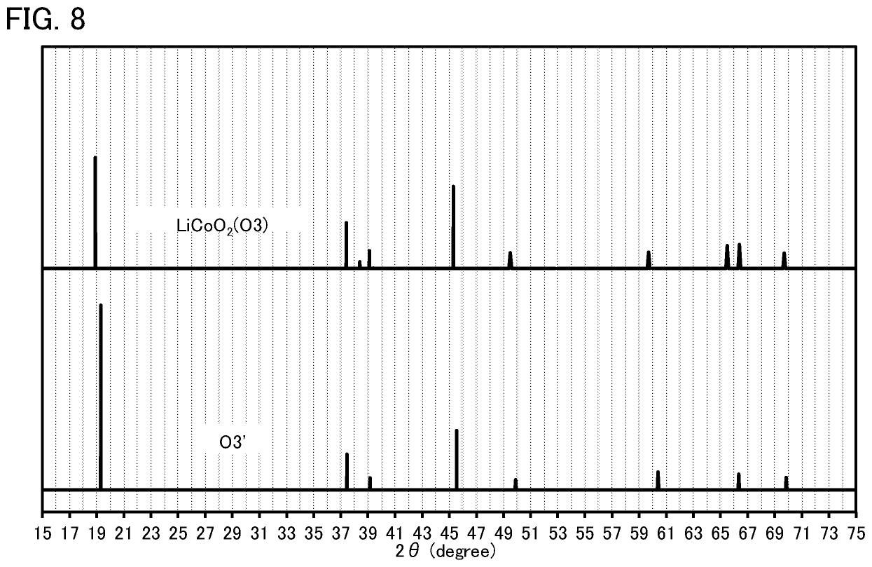

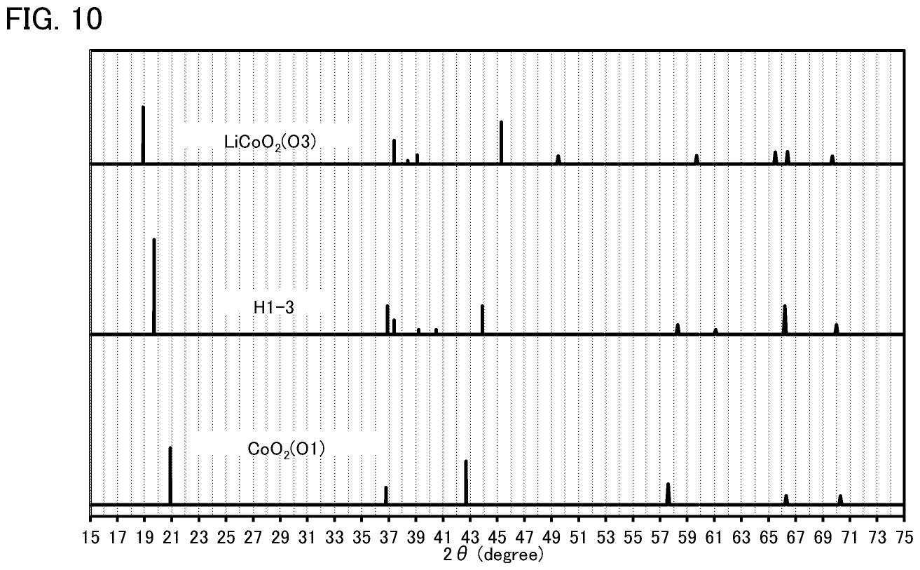

FIG. 8 and FIG. 10 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with a charge depth of 0 and the crystal structure of CoO₂ (O1) with a charge depth of 1 are also shown. Note that the patterns of LiCoO₂ (O3) and CoO₂ (O1) were made from crystal structure data obtained from the ICSD (Inorganic Crystal Structure Database) (see Non-Patent Document 4) with Reflex Powder Diffraction, which is a module of Materials Studio (BIOVIA). The range of 2θ was from 15° (degree) to 75°, the step size was 0.01, the wavelength λ1 was 1.540562×10⁻¹⁰ m, the wavelength λ2 was not set, and a single monochromator was used. The pattern of the H1-3 type crystal structure was similarly made from the crystal structure data disclosed in Non-Patent Document 3. The O3′ type crystal structure was estimated from the XRD pattern of the positive electrode active material of one embodiment of the present invention, the crystal structure was fitted with TOPAS ver. 3 (crystal structure analysis software produced by Bruker Corporation), and the XRD pattern of the O3′ type crystal structure was made in a similar manner to other structures.

As shown in FIG. 8, the O3′ type crystal structure exhibits diffraction peaks at 2θ of 19.30±0.20° (greater than or equal to 19.10° and less than or equal to 19.50°) and 2θ of 45.55±0.10° (greater than or equal to 45.450 and less than or equal to 45.65°). More specifically, the O3′ type crystal structure exhibits sharp diffraction peaks at 2θ of 19.30±0.10° (greater than or equal to 19.20° and less than or equal to 19.40°) and 2θ of 45.55±0.05° (greater than or equal to 45.50° and less than or equal to 45.60). By contrast, as shown in FIG. 10, the H1-3 type crystal structure and CoO₂ (P-3 ml, O1) do not exhibit peaks at these positions. Thus, the peaks at 2θ of 19.30±0.20° and 2θ of 45.55±0.10° in a high-voltage charged state can be the features of the positive electrode active material 100 of one embodiment of the present invention.

It can be said that the positions of the XRD diffraction peaks exhibited by the crystal structure with a charge depth of 0 are close to those of the XRD diffraction peaks exhibited by the crystal structure at the time of high-voltage charging. More specifically, it can be said that a difference in the positions of two or more, preferably three or more of the main diffraction peaks between the crystal structures is 2θ=0.7 or less, preferably 2θ=0.5 or less.

Although the positive electrode active material 100 of one embodiment of the present invention has the O3′ type crystal structure at the time of high-voltage charging, not all the particles necessarily have the O3′ type crystal structure. Some of the particles may have another crystal structure or be amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charging and discharging after the measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material particle is only decreased to approximately one-tenth that of LiCoO₂ (O3) in a discharged state. Thus, the peak of the O3′ type crystal structure can be clearly observed after high-voltage charging even under the same XRD measurement conditions as those of a positive electrode before charging and discharging. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as the transition metal M. The positive electrode active material of one embodiment of the present invention may contain the above-described metal Z in addition to cobalt as long as the influence of the Jahn-Teller effect is small.

The range of the lattice constants where the influence of the Jahn-Teller effect is presumed to be small in the positive electrode active material is examined by XRD analysis.

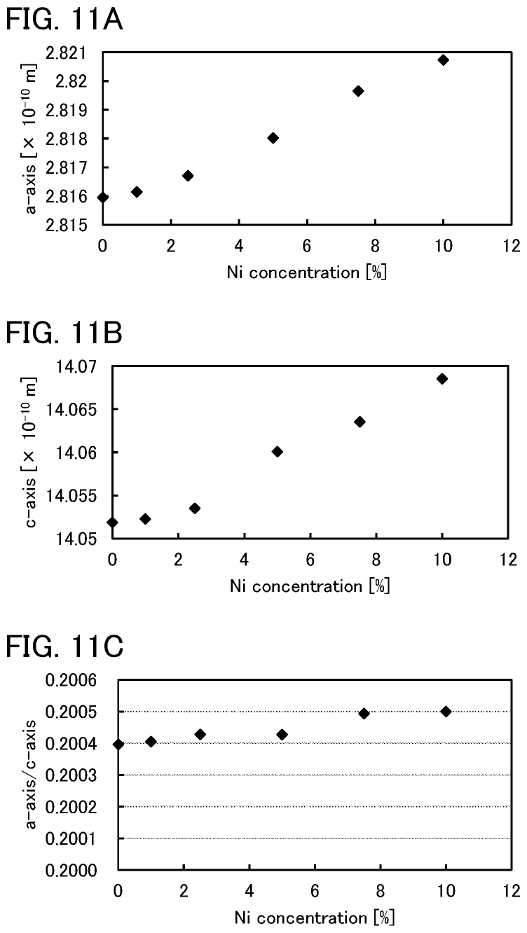

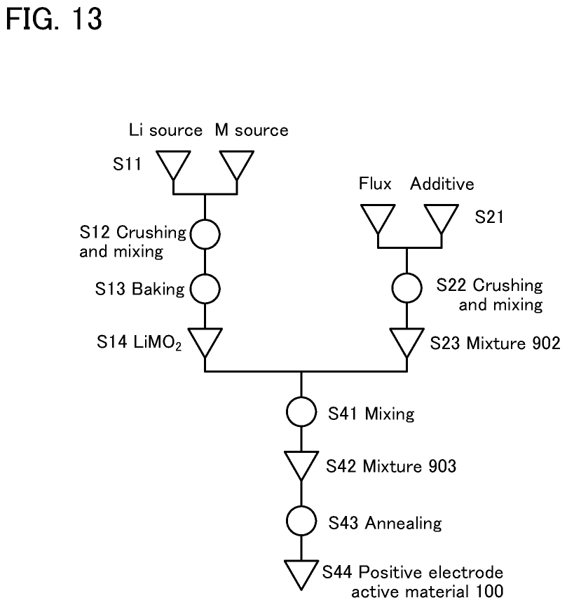

FIG. 11 shows the calculation results of the lattice constants of the a-axis and the c-axis by XRD in the case where the positive electrode active material of one embodiment of the present invention has a layered rock-salt crystal structure and contains cobalt and nickel. FIG. 11A shows the results of the a-axis, and FIG. 11B shows the results of the c-axis. Note that the lattice constants shown in FIG. 11 were obtained by XRD measurement of a powder after the synthesis of the positive electrode active material before incorporation into a positive electrode. The nickel concentration on the horizontal axis represents a nickel concentration with the sum of cobalt atoms and nickel atoms regarded as 100%. The positive electrode active material is formed through Step S14 to Step S44, which are described with reference to FIG. 13, and a nickel source is used in Step S21. The nickel concentration represents a nickel concentration with the sum of cobalt atoms and nickel atoms regarded as 100% in Step S21.

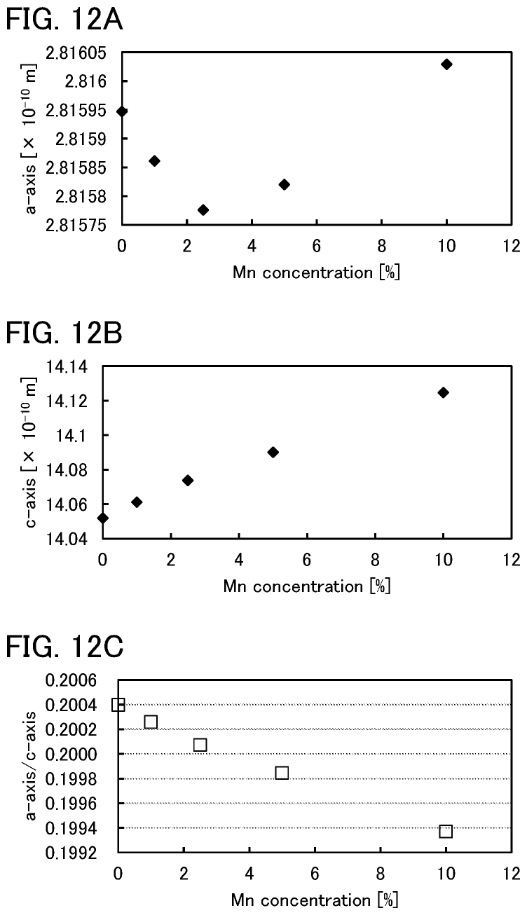

FIG. 12 shows the estimation results of the lattice constants of the a-axis and the c-axis by XRD in the case where the positive electrode active material of one embodiment of the present invention has a layered rock-salt crystal structure and contains cobalt and manganese. FIG. 12A shows the results of the a-axis, and FIG. 12B shows the results of the c-axis. Note that the lattice constants shown in FIG. 12 were obtained by XRD measurement of a powder after the synthesis of the positive electrode active material before incorporation into a positive electrode. The manganese concentration on the horizontal axis represents a manganese concentration with the sum of cobalt atoms and manganese atoms regarded as 100%. The positive electrode active material is formed through Step S14 to Step S44, which are described with reference to FIG. 13, and a manganese source is used in Step S21. The manganese concentration represents a manganese concentration with the sum of cobalt atoms and manganese atoms regarded as 100% in Step S21.

FIG. 11C shows values obtained by dividing the lattice constants of the a-axis by the lattice constants of the c-axis (a-axis/c-axis) in the positive electrode active material, whose results of the lattice constants are shown in FIG. 11A and FIG. 11B. FIG. 12C shows values obtained by dividing the lattice constants of the a-axis by the lattice constants of the c-axis (a-axis/c-axis) in the positive electrode active material, whose results of the lattice constants are shown in FIG. 12A and FIG. 12B.

As shown in FIG. 11C, the value of a-axis/c-axis tends to significantly change between nickel concentrations of 5% and 7.5%, and the distortion of the a-axis becomes large. This distortion may be the Jahn-Teller distortion. It is suggested that an excellent positive electrode active material with small Jahn-Teller distortion can be obtained at a nickel concentration of lower than 7.5%.

FIG. 12A indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Note that the nickel concentration and the manganese concentration in the surface portion 100a of the particle are not limited to the above ranges. In other words, the nickel concentration and the manganese concentration in the surface portion 100a of the particle may be higher than the above concentrations in some cases.

Preferable ranges of the lattice constants of the positive electrode active material of one embodiment of the present invention are examined above. In the layered rock-salt crystal structure of the particle of the positive electrode active material in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be the state of a powder before the formation of a positive electrode of a secondary battery, for example.

Alternatively, in the layered rock-salt crystal structure of the particle of the positive electrode active material in the discharged state or the state where charging and discharging are not performed, the value obtained by dividing the a-axis lattice constant by the c-axis lattice constant (a-axis/c-axis) is preferably greater than 0.20000 and less than 0.20049.

Alternatively, when the layered rock-salt crystal structure of the particle of the positive electrode active material in the discharged state or the state where charging and discharging are not performed is subjected to XRD analysis, a first peak is observed at 2θ of greater than or equal to 18.50° and less than or equal to 19.30°, and a second peak is observed at 2θ of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a, the outermost surface layer, or the like can be analyzed by electron diffraction of a cross section of the positive electrode active material 100, for example.

### <<XPS>>

A region that is approximately 2 to 8 nm (normally, approximately 5 nm) in depth from a surface can be analyzed by X-ray photoelectron spectroscopy (XPS); thus, the concentrations of elements in approximately half the surface portion 100a can be quantitatively analyzed. The bonding states of the elements can be analyzed by narrow scanning. Note that the quantitative accuracy of XPS is approximately ±1 atomic % in many cases. The lower detection limit is approximately 1 atomic % but depends on the element.

When the positive electrode active material 100 of one embodiment of the present invention is subjected to XPS analysis, the number of atoms of the additive is preferably greater than or equal to 1.6 times and less than or equal to 6.0 times, further preferably greater than or equal to 1.8 times and less than 4.0 times the number of atoms of the transition metal M. When the additive is magnesium and the transition metal M is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of halogen such as fluorine is preferably greater than or equal to 0.2 times and less than or equal to 6.0 times, further preferably greater than or equal to 1.2 times and less than or equal to 4.0 times the number of atoms of the transition metal M.

In the XPS analysis, monochromatic aluminum can be used as an X-ray source, for example. An extraction angle is, for example, 45°.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the additives that preferably exist in the surface portion 100a in a large amount, such as magnesium and aluminum, measured by XPS or the like are preferably higher than the concentrations measured by ICP-MS (inductively coupled plasma mass spectrometry), GD-MS (glow discharge mass spectrometry), or the like.

When a cross section of the positive electrode active material 100 is exposed by processing and analyzed by TEM-EDX, the concentrations of magnesium and aluminum in the surface portion 100a are preferably higher than those in the inner portion 100b. An FIB can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals M, not be unevenly distributed in the surface portion 100a but be distributed in the entire positive electrode active material 100. Note that one embodiment of the present invention is not limited thereto in the case where the above-described region where the excess additives are unevenly distributed exists.

### <<EPMA>>

Elements can be quantified by EPMA (electron probe microanalysis). In surface analysis, distribution of each element can be analyzed.

In EPMA, a region from a surface to a depth of approximately 1 m is analyzed. Thus, the concentration of each element is sometimes different from measurement results obtained by other analysis methods. For example, when surface analysis is performed on the positive electrode active material 100, the concentration of the additive existing in the surface portion might be lower than the concentration obtained in XPS. The concentration of the additive existing in the surface portion might be higher than the concentration obtained in ICP-MS or a value based on the ratio of the raw materials mixed in the process of forming the positive electrode active material.

EPMA surface analysis of a cross section of the positive electrode active material 100 of one embodiment of the present invention preferably reveals a concentration gradient in which the concentration of the additive increases from the inner portion toward the surface portion. Specifically, each of magnesium, fluorine, titanium, and silicon preferably has a concentration gradient in which the concentration increases from the inner portion toward the surface as illustrated in FIG. 1B1. The concentration of aluminum preferably has a peak in a region deeper than the region where the concentration of any of the above elements has a peak, as illustrated in FIG. 1B2. The aluminum concentration peak may be located in the surface portion or located deeper than the surface portion.

Note that the surface and the surface portion of the positive electrode active material of one embodiment of the present invention do not contain a carbonic acid, a hydroxy group, or the like which is chemisorbed after formation of the positive electrode active material. Furthermore, an electrolyte solution, a binder, a conductive material, and a compound originating from any of these that are attached to the surface of the positive electrode active material are not contained either. Thus, in quantification of the elements contained in the positive electrode active material, correction may be performed to exclude carbon, hydrogen, excess oxygen, excess fluorine, and the like that might be detected in surface analysis such as XPS and EPMA.

### EMBODIMENT 2

In this embodiment, an example of a method for forming the positive electrode active material 100 of one embodiment of the present invention will be described with reference to FIG. 13 to FIG. 16.

### <Step S11>

First, in Step S11 in FIG. 13, a lithium source and a transition metal M source are prepared as materials of a composite oxide (LiMO₂) containing lithium, the transition metal M, and oxygen.

As the lithium source, for example, lithium carbonate, lithium fluoride, or the like can be used.

As the transition metal M, a metal that can form, together with lithium, a composite oxide having the layered rock-salt structure belonging to the space group R-3m is preferably used. For example, at least one of manganese, cobalt, and nickel can be used. That is, as the transition metal M source, only cobalt may be used; only nickel may be used; two types of metals of cobalt and manganese or cobalt and nickel may be used; or three types of metals of cobalt, manganese, and nickel may be used.

When metals that can form a composite oxide having the layered rock-salt structure are used, cobalt, manganese, and nickel are preferably mixed at the ratio at which the composite oxide can have the layered rock-salt crystal structure. In addition, aluminum may be added to the transition metal as long as the composite oxide can have the layered rock-salt crystal structure.

As the transition metal M source, an oxide or a hydroxide of the metal described as an example of the transition metal M, or the like can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S12>

Next, in Step S12, the lithium source and the transition metal M source are mixed. The mixing can be performed by a dry process or a wet process. For example, a ball mill, a bead mill, or the like can be used for the mixing. When the ball mill is used, a zirconia ball is preferably used as grinding media, for example.

### <Step S13>

Next, in Step S13, the materials mixed in the above manner are heated. This step is sometimes referred to as baking or first heating to distinguish this step from a heating step performed later. The heating is preferably performed at higher than or equal to 800° C. and lower than 1100° C., further preferably at higher than or equal to 900° C. and lower than or equal to 1000° C., still further preferably at approximately 950° C. Alternatively, the heating is preferably performed at higher than or equal to 800° C. and lower than or equal to 1000° C. Alternatively, the heating is preferably performed at higher than or equal to 900° C. and lower than or equal to 1100° C. An excessively low temperature might lead to insufficient decomposition and melting of the lithium source and the transition metal M source. An excessively high temperature, on the other hand, might cause a defect due to excessive reduction of the metal taking part in an oxidation-reduction reaction and used as the transition metal M, evaporation of lithium, or the like. The use of cobalt as the transition metal M, for example, may lead to a defect in which cobalt has divalence.

The heating time can be longer than or equal to an hour and shorter than or equal to 100 hours, for example, and is preferably longer than or equal to 2 hours and shorter than or equal to 20 hours. Alternatively, the heating time is preferably longer than or equal to an hour and shorter than or equal to 20 hours. Alternatively, the heating time is preferably longer than or equal to 2 hours and shorter than or equal to 100 hours. Baking is preferably performed in an atmosphere with few moisture, such as dry air (e.g., the dew point is lower than or equal to −50° C., further preferably lower than or equal to −100° C.). For example, it is preferable that the heating be performed at 1000° C. for 10 hours, the temperature rise be 200° C./h, and the flow rate of a dry atmosphere be 10 L/min. After that, the heated materials can be cooled to room temperature (25° C.). The temperature decreasing time from the specified temperature to room temperature is preferably longer than or equal to 10 hours and shorter than or equal to 50 hours, for example.

Note that the cooling to room temperature in Step S13 is not essential. As long as later steps of Step S41 to Step S44 are performed without problems, the cooling may be performed to a temperature higher than room temperature.

### <Step S14>

Next, in Step S14, the materials baked in the above manner are collected, whereby the composite oxide (LiMO₂) containing lithium, the transition metal M, and oxygen is obtained. Specifically, lithium cobalt oxide, lithium manganese oxide, lithium nickel oxide, lithium cobalt oxide in which manganese is substituted for part of cobalt, lithium cobalt oxide in which nickel is substituted for part of cobalt, lithium nickel-manganese-cobalt oxide, or the like is obtained.

Alternatively, a composite oxide containing lithium, the transition metal M, and oxygen that is synthesized in advance may be used in Step S14. In that case, Step S11 to Step S13 can be omitted.

For example, as a composite oxide synthesized in advance, a lithium cobalt oxide particle (product name: Cellseed C-10N) produced by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

Alternatively, a lithium cobalt oxide particle (product name: Cellseed C-5H) produced by NIPPON CHEMICAL INDUSTRIAL CO., LTD. can be used. This is lithium cobalt oxide in which the average particle diameter (D50) is approximately 6.5 m, and the concentrations of elements other than lithium, cobalt, and oxygen are approximately equal to or less than those of C-TON in the impurity analysis by GD-MS.

In this embodiment, cobalt is used as the metal M, and the lithium cobalt oxide particle synthesized in advance (Cellseed C-TON produced by NIPPON CHEMICAL INDUSTRIAL CO., LTD.) is used.

### <Step S21>

Next, in Step S21, a material serving as a flux (Flux in the figure) and an additive that contributes to the stabilization of a crystal structure (Additive in the figure) are prepared as materials of a mixture 902. As the material serving as a flux and the additive that contributes to the stabilization of a crystal structure, the materials described in the above embodiment can be used.

In addition, a lithium source is preferably prepared as well. As the lithium source, for example, lithium fluoride, lithium carbonate, or the like can be used. That is, lithium fluoride can be used as both the lithium source and the material serving as a flux.

In this embodiment, lithium fluoride LiF is prepared as the material serving as a flux, and magnesium fluoride MgF₂ is prepared as the additive that contributes to the stabilization of a crystal structure. When lithium fluoride LiF and magnesium fluoride MgF₂ are mixed at a molar ratio of approximately LiF:MgF₂=65:35, the effect of lowering the melting point becomes the highest. On the other hand, when the amount of lithium fluoride increases, cycle performance might deteriorate because of a too large amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33). Note that in this specification and the like, the vicinity means a value greater than 0.9 times and smaller than 1.1 times a certain value.

In addition, in the case where the following mixing and grinding steps are performed by a wet process, a solvent is prepared. As the solvent, ketone such as acetone; alcohol such as ethanol or isopropanol; ether such as diethyl ether; dioxane; acetonitrile; N-methyl-2-pyrrolidone (NMP); or the like can be used. An aprotic solvent that hardly reacts with lithium is further preferably used. In this embodiment, acetone is used.

### <Step S22>

Next, in Step S22, the materials of the mixture 902 are mixed and ground. Although the mixing can be performed by a dry process or a wet process, the wet process is preferable because the materials can be ground to the smaller size. For example, a ball mill, a bead mill, or the like can be used for the mixing. When the ball mill is used, a zirconia ball is preferably used as grinding media, for example. The mixing step and the grinding step are preferably performed sufficiently to pulverize the mixture 902.

### <Step S23>

Next, in Step S23, the materials mixed and ground in the above manner are collected, whereby the mixture 902 is obtained.

For example, the mixture 902 preferably has a D50 (median diameter) of greater than or equal to 600 nm and less than or equal to 20 μm, further preferably greater than or equal to 1 μm and less than or equal to 10 μm. Alternatively, the D50 is preferably greater than or equal to 600 nm and less than or equal to 10 μm. Alternatively, the D50 is preferably greater than or equal to 1 μm and less than or equal to 20 μm. When mixed with a composite oxide containing lithium, the transition metal M, and oxygen in the later step, the mixture 902 pulverized to such a small size is easily attached to surfaces of composite oxide particles uniformly. The mixture 902 is preferably attached to the surfaces of the composite oxide particles uniformly because both halogen and magnesium are easily distributed to the surface portion of the composite oxide particles after heating. When there is a region containing neither halogen nor magnesium in the surface portion, the positive electrode active material might be less likely to have the O3′ type crystal structure, which is described later, in the charged state.

### <Step S41>

Next, in Step S41, LiMO₂ obtained in Step S14 and the mixture 902 are mixed. The atomic ratio of the transition metal M in the composite oxide containing lithium, the transition metal M, and oxygen to magnesium Mg in the mixture 902 is preferably M:Mg=100:y (0.1≤y≤6), further preferably M:Mg=100:y (0.3≤y≤3).

The conditions of the mixing in Step S41 are preferably milder than those of the mixing in Step S12 in order not to damage the particles of the composite oxide. For example, conditions with a lower rotation frequency or shorter time than the mixing in Step S12 are preferable. In addition, it can be said that conditions of the dry process are less likely to break the particles than those of the wet process. For example, a ball mill, a bead mill, or the like can be used for the mixing. When the ball mill is used, a zirconia ball is preferably used as grinding media, for example.

### <Step S42>

Next, in Step S42, the materials mixed in the above manner are collected, whereby a mixture 903 is obtained.

Note that this embodiment describes a method for adding the mixture of lithium fluoride and magnesium fluoride to lithium cobalt oxide with few impurities; however, one embodiment of the present invention is not limited thereto. A mixture obtained through baking after addition of a magnesium source, a fluorine source, and the like to the starting material of lithium cobalt oxide may be used instead of the mixture 903 in Step S42. In that case, there is no need to separate steps of Step S11 to Step S14 and steps of Step S21 to Step S23, which is simple and productive.

Alternatively, lithium cobalt oxide to which magnesium and fluorine are added in advance may be used. When lithium cobalt oxide to which magnesium and fluorine are added is used, the process can be simpler because steps up to Step S42 can be omitted.

In addition, a magnesium source and a fluorine source may be further added to the lithium cobalt oxide to which magnesium and fluorine are added in advance.

### <Step S43>

Next, in Step S43, the mixture 903 is heated in an atmosphere containing oxygen. The heating further preferably has the adhesion preventing effect to prevent particles of the mixture 903 from adhering to one another. This step is sometimes referred to as annealing to distinguish this step from the heating step performed before.

Examples of the heating having the adhesion preventing effect are heating while the mixture 903 is being stirred and heating while a container containing the mixture 903 is being vibrated.

The heating temperature in Step S43 needs to be higher than or equal to the temperature at which a reaction between LiMO₂ and the mixture 902 proceeds. Here, the temperature at which the reaction proceeds is a temperature at which interdiffusion between elements included in LiMO₂ and the mixture 902 occurs. Thus, the heating temperature may be lower than the melting temperatures of these materials. For example, in an oxide, solid-phase diffusion occurs at a temperature that is 0.757 times (Tamman temperature T_{d}) the melting temperature Tₘ. Accordingly, for example, the heating temperature is higher than or equal to 500° C.

A temperature higher than or equal to the temperature at which at least part of the mixture 903 is melted is preferable because the reaction proceeds more easily. Accordingly, the annealing temperature is preferably higher than or equal to the eutectic point of the mixture 902 or the mixture 903.

In the case where the mixture 902 includes LiF and MgF₂, the eutectic point of LiF and MgF₂ is around 742° C., and the temperature in Step S43 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Thus, the annealing temperature is further preferably higher than or equal to 830° C.

A higher annealing temperature is preferable because it facilitates the reaction, shortens the annealing time, and enables high productivity.

Note that the annealing temperature needs to be lower than or equal to a decomposition temperature of LiMO₂ (1130° C. in the case of LiCoO₂). At around the decomposition temperature, a slight amount of LiMO₂ might be decomposed. Thus, the annealing temperature is preferably lower than or equal to 1130° C., further preferably lower than or equal to 1000° C., still further preferably lower than or equal to 950° C., yet still further preferably lower than or equal to 900° C.

In view of the above, the annealing temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the annealing temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the annealing temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 903, the partial pressure of fluorine or a fluoride in the atmosphere is preferably controlled to be within an appropriate range.

In the formation method described in this embodiment, LiF functions as a flux. Owing to this function, the annealing temperature can be lower than or equal to the decomposition temperature of LiMO₂, e.g., a temperature higher than or equal to 742° C. and lower than or equal to 950° C., which allows distribution of the additive such as magnesium in the surface portion and formation of the positive electrode active material having favorable performance.

Since LiF is lighter in weight than oxygen, when LiF vaporizes by heating, LiF in the mixture 903 decreases. As a result, the function of a flux deteriorates. Therefore, heating needs to be performed while volatilization of LiF is inhibited. Note that even when LiF is not used as the fluorine source or the like, there is a possibility in that Li and F at a surface of LiMO₂ react with each other to generate LiF and vaporize. Therefore, such inhibition of volatilization is necessary also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

The annealing is preferably performed for an appropriate time. The appropriate annealing time is changed depending on conditions, such as the annealing temperature, and the particle size and composition of LiMO₂ in Step S14. In the case where the particle size is small, the annealing is preferably performed at a lower temperature or for a shorter time than the case where the particle size is large, in some cases.

When the average particle diameter (D50) of the particles in Step S14 is approximately 12 m, for example, the annealing temperature is preferably higher than or equal to 600° C. and lower than or equal to 950° C., for example. The annealing time is preferably longer than or equal to 3 hours, further preferably longer than or equal to 10 hours, still further preferably longer than or equal to 60 hours, for example.

On the other hand, when the average particle diameter (D50) of the particles in Step S14 is approximately 5 m, the annealing temperature is preferably higher than or equal to 600° C. and lower than or equal to 950° C., for example. The annealing time is preferably longer than or equal to an hour and shorter than or equal to 10 hours, further preferably approximately 2 hours, for example.

The temperature decreasing time after the annealing is, for example, preferably longer than or equal to 10 hours and shorter than or equal to 50 hours.

### <Step S44>

Next, in Step S44, the material annealed in the above manner is collected, whereby the positive electrode active materials 100 can be formed. Here, the collected particles are preferably made to pass through a sieve. Through the sieve, adhesion between the positive electrode active material particles can be solved.

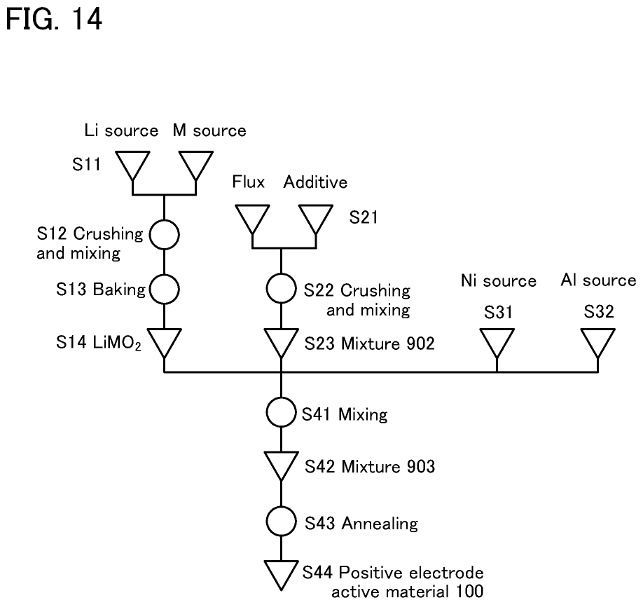

Next, a formation method different from that of FIG. 13 will be described with reference to FIG. 14 to FIG. 16. Many portions are common to FIG. 13; hence, different portions will be mainly described. The description of FIG. 13 can be referred to for the common portions.

Although FIG. 13 shows the formation method in which LiMO₂ obtained in Step S14 and the mixture 902 are mixed in Step S41, one embodiment of the present invention is not limited to this. As in Step S31 and Step S32 in FIG. 14 to FIG. 16, another additive may be further mixed.

For the other materials used as the additive, refer to the description of the additive that contributes to the stabilization of a crystal structure in the above embodiment. FIG. 14 to FIG. 16 show an example in which two kinds of additives, i.e., a nickel source in Step S31 and an aluminum source in Step S32, are used.

These additives are preferably obtained by pulverizing an oxide, a hydroxide, a fluoride, or the like of the elements. The pulverization can be performed by a wet process, for example.

As shown in FIG. 14, the nickel source and the aluminum source can be mixed at the same time as the mixture 902 is mixed in Step S41. This method is preferable for high productivity since the number of annealing times is small.

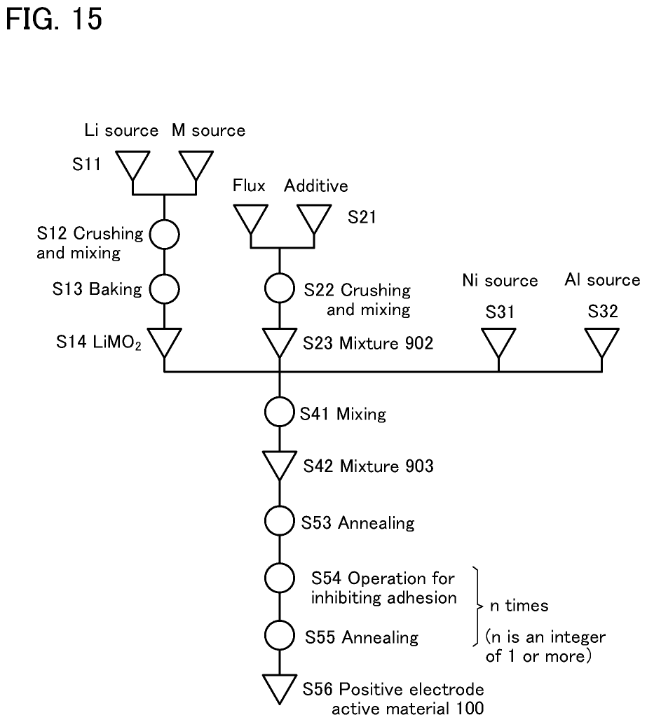

As shown in FIG. 15, annealing may be performed a plurality of times in Step S53 and Step S55, between which Step S54 of operation for inhibiting adhesion may be performed. For the annealing conditions of Step S53 and Step S55, the description of Step S43 in FIG. 13 can be referred to. Examples of the operation for inhibiting adhesion include crushing with a pestle, mixing with a ball mill, mixing with a planetary centrifugal mixer, making the mixture pass through a sieve, and vibrating a container containing the composite oxide.

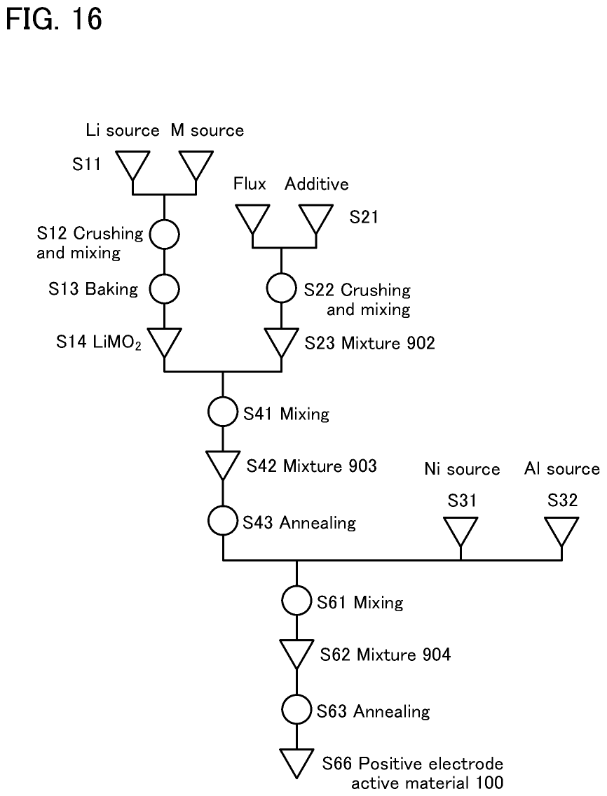

As shown in FIG. 16, LiMO₂ and the mixture 902 are mixed in Step S41 and annealed, and after that, a nickel source and an aluminum source may be mixed in Step S61. The mixture here is referred to as a mixture 904 (Step S62). The mixture 904 is annealed again in Step S63. For the annealing conditions, the description of Step S43 in FIG. 13 can be referred to.

When the steps of using and introducing a plurality of additives are separately performed as in the formation methods shown in FIG. 14 to FIG. 16, the profiles in the depth direction of the elements can be made different from each other in some cases. For example, the concentrations of some of the additives can be made higher in the surface portion than in the inner portion of the particle.

This embodiment can be used in combination with the other embodiments.

### EMBODIMENT 3

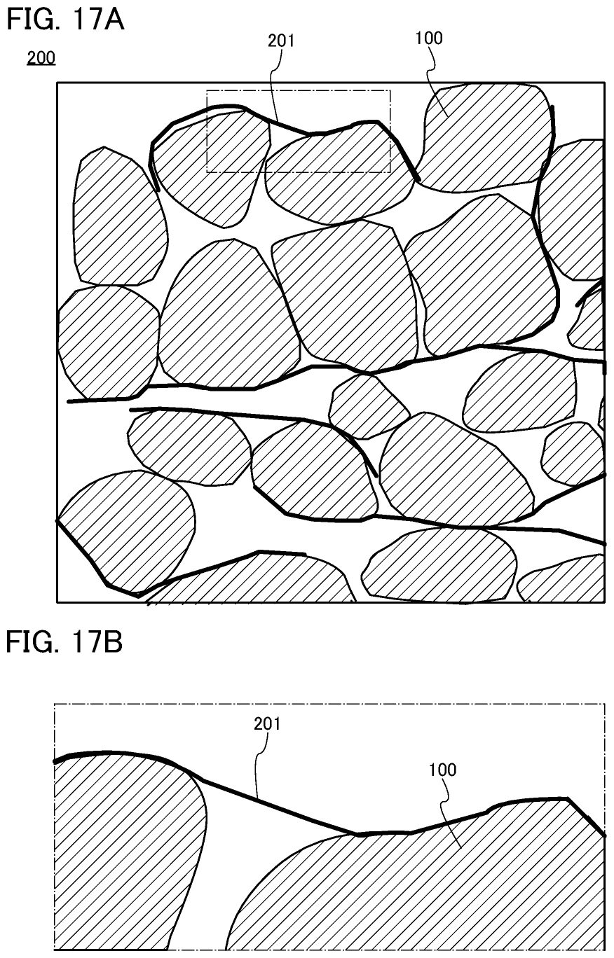

In this embodiment, examples of a secondary battery of one embodiment of the present invention are described with reference to FIG. 17 to FIG. 20.

### Structure Example 1 of Secondary Battery

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material and a binder. As the positive electrode active material, the positive electrode active material formed by the formation method described in the above embodiments is used.

The positive electrode active material described in the above embodiments and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O4, V₂O₅, Cr₂O₅, or MnO₂ can be used.

As another positive electrode active material, it is preferable to add lithium nickel oxide (LiNiO₂ or LiNi₁₋ₓMₓO₂ (0<x<1) (M=Co, Al, or the like)) to a lithium-containing material with a spinel crystal structure which contains manganese, such as LiMn₂O₄, because the performance of the secondary battery including such a material can be improved.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICP-MS combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

A cross-sectional structure example of an active material layer 200 containing a graphene compound as a conductive material is described below.

FIG. 17A is a longitudinal cross-sectional view of the active material layer 200. The active material layer 200 includes particles of the positive electrode active material 100, a graphene compound 201 serving as the conductive material, and a binder (not illustrated).

The graphene compound 201 in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

The longitudinal cross section of the active material layer 200 in FIG. 17B shows substantially uniform dispersion of the sheet-like graphene compounds 201 in the active material layer 200. The graphene compounds 201 are schematically shown by the thick lines in FIG. 17B but are actually thin films each having a thickness corresponding to the thickness of a single layer or a multi-layer of carbon molecules. The plurality of graphene compounds 201 are formed to partly coat or adhere to the surfaces of the plurality of particles of the positive electrode active material 100, so that the plurality of graphene compounds 201 make surface contact with the particles of the positive electrode active material 100.

Here, the plurality of graphene compounds can be bonded to each other to form a net-like graphene compound sheet (hereinafter, referred to as a graphene compound net or a graphene net). A graphene net that covers the active material can function as a binder for bonding active materials. Accordingly, the amount of the binder can be reduced, or the binder does not have to be used. This can increase the proportion of the active material in the electrode volume and weight. That is to say, the charge and discharge capacity of the secondary battery can be increased.

Here, it is preferable to perform reduction after a layer to be the active material layer 200 is formed in such a manner that graphene oxide is used as the graphene compound 201 and mixed with an active material. That is, the formed active material layer preferably contains reduced graphene oxide. When graphene oxide with extremely high dispersibility in a polar solvent is used for the formation of the graphene compound 201, the graphene compound 201 can be substantially uniformly dispersed in the active material layer 200. The solvent is removed by volatilization from a dispersion medium in which graphene oxide is uniformly dispersed, and the graphene oxide is reduced; hence, the graphene compounds 201 remaining in the active material layer 200 partly overlap with each other and are dispersed such that surface contact is made, thereby forming a three-dimensional conduction path. Note that graphene oxide can be reduced by heat treatment or with the use of a reducing agent, for example.

Unlike a conductive material in the form of particles, such as acetylene black, which makes point contact with an active material, the graphene compound 201 is capable of making low-resistance surface contact; accordingly, the electrical conduction between the particles of the positive electrode active material 100 and the graphene compound 201 can be improved with a small amount of the graphene compound 201 compared with a normal conductive material. Thus, the proportion of the positive electrode active material 100 in the active material layer 200 can be increased, resulting in increased discharge capacity of the secondary battery.

It is possible to form, with a spray dry apparatus, a graphene compound serving as a conductive material as a coating film to cover the entire surface of the active material in advance and to form a conductive path between the active materials using the graphene compound.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles used as the catalyst is preferably less than or equal to 1 m, further preferably less than or equal to 100 nm.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher charge and discharge capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄TisO₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride of lithium and the transition metal M, can be used. For example, Li_{2.6}Co_{0.4}N₃ is preferable because of high charge and discharge capacity (900 mAh/g and 1890 mAh/cm³).

A composite nitride of lithium and the transition metal M is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and the transition metal M can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatize as the solvent of the electrolyte solution can prevent an internal short circuit of a secondary battery. In addition, a secondary battery can be prevented from exploding or catching fire, for example, even when the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(C₂F₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte solution used for a secondary battery is preferably highly purified and contains small numbers of dust particles and elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like may alternatively be used. When the solid electrolyte is used, a separator or a spacer is not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery can be improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the charge and discharge capacity per volume of the secondary battery can be increased because the safety of the secondary battery can be maintained even when the total thickness of the separator is small.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Structure Example 2 of Secondary Battery

A structure of a secondary battery including a solid electrolyte layer is described below as another structure example of a secondary battery.

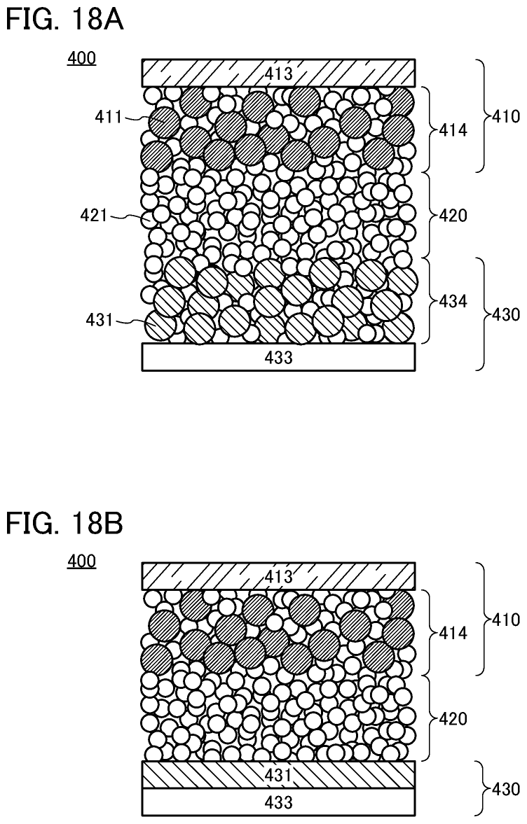

As illustrated in FIG. 18A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the formation method described in the above embodiments is used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metal lithium is used for the negative electrode 430, it is possible that the negative electrode 430 does not include the solid electrolyte 421 as illustrated in FIG. 18B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·38SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄₋Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃(0<x<1) having a NASICON crystal structure (hereinafter, LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃(M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

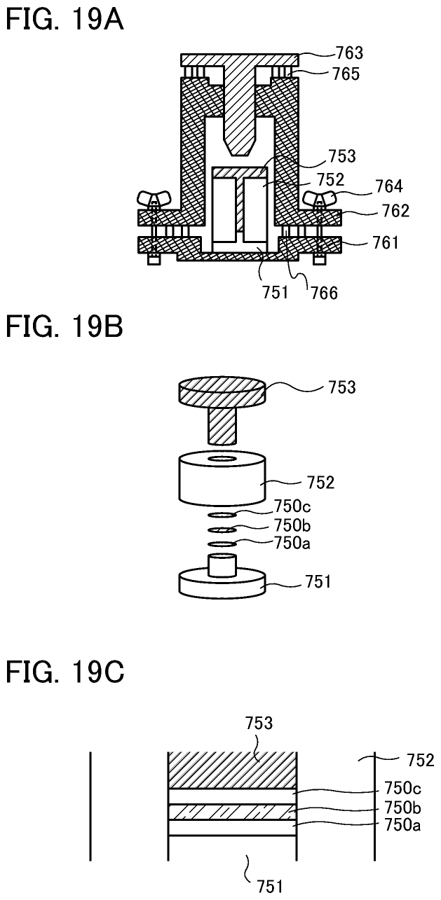

FIG. 19 illustrates an example of a cell for evaluating materials of an all-solid-state battery.

FIG. 19A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 19B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 19C. Note that the same portions in FIG. 19A, FIG. 19B, and FIG. 19C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package and/or a resin package can be used. The exterior body is sealed preferably in a closed atmosphere where the outside air is blocked, for example, in a glove box.

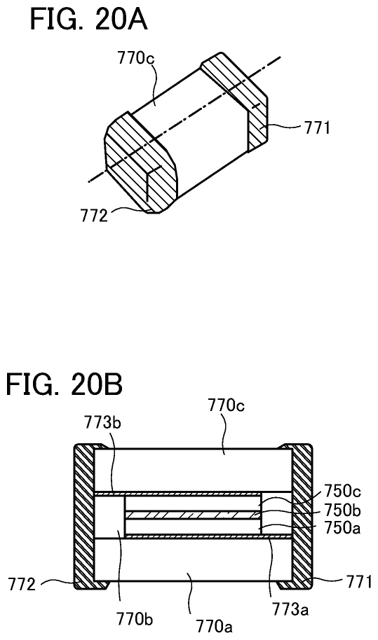

FIG. 20A is a perspective view of a secondary battery of one embodiment of the present invention that has an exterior body and a shape different from those in FIG. 19. The secondary battery in FIG. 20A includes external electrodes 771 and 772 and is sealed with an exterior body including a plurality of package components.

FIG. 20B illustrates an example of a cross section along the dashed-dotted line in FIG. 20A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and/or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with any of the other embodiments.

### EMBODIMENT 4

In this embodiment, examples of a shape of a secondary battery including the positive electrode described in the above embodiment are described. For the materials used for the secondary battery described in this embodiment, the description of the above embodiment can be referred to.

### <Coin-Type Secondary Battery>

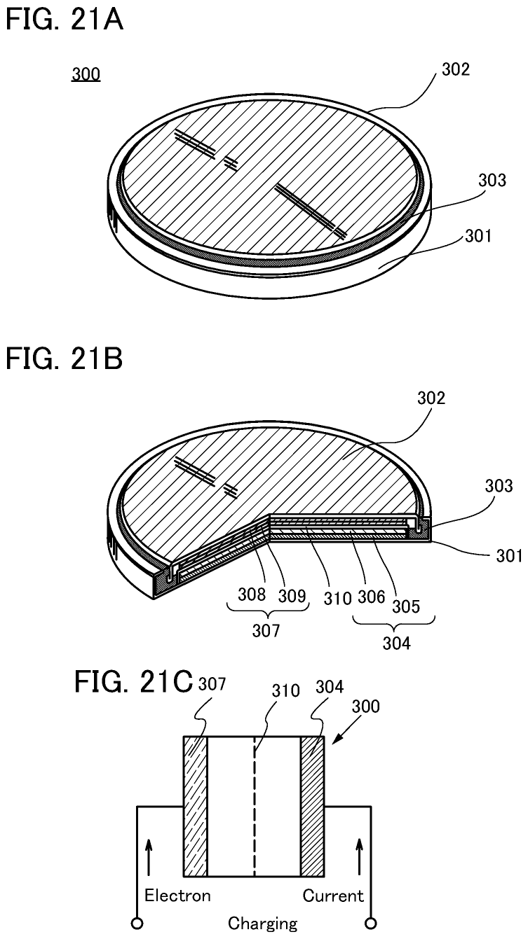

First, an example of a coin-type secondary battery is described. FIG. 21A is an external view of a coin-type (single-layer flat type) secondary battery, and FIG. 21B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, and an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are soaked in the electrolyte. Then, as illustrated in FIG. 21B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 is manufactured.

When the positive electrode active material described in the above embodiment is used in the positive electrode 304, the coin-type secondary battery 300 with high charge and discharge capacity and excellent cycle performance can be obtained.

Here, a current flow in charging a secondary battery is described with reference to FIG. 21C. When a secondary battery using lithium is regarded as a closed circuit, movement of lithium ions and the current flow are in the same direction. Note that in the secondary battery using lithium, the anode and the cathode interchange in charging and discharging, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charging is performed, discharging is performed, a reverse pulse current is supplied, and a charge current is supplied. The use of the terms “anode” and “cathode” related to an oxidation reaction and a reduction reaction might cause confusion because the anode and the cathode interchange in charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive (plus) electrode or a negative (minus) electrode.

Two terminals illustrated in FIG. 21C are connected to a charger, and the secondary battery 300 is charged. As the charge of the secondary battery 300 proceeds, a potential difference between electrodes increases.

### <Cylindrical Secondary Battery>

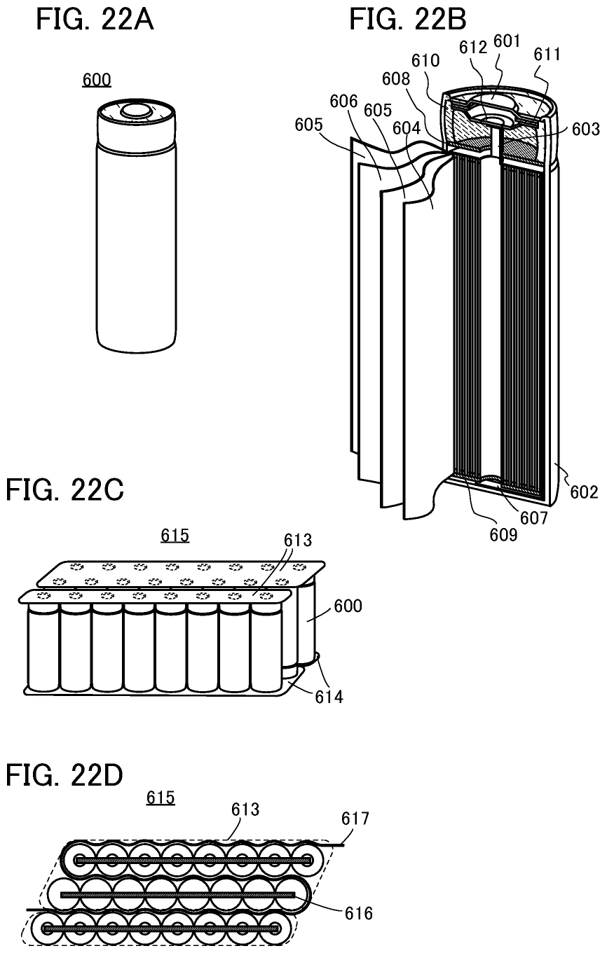

Next, an example of a cylindrical secondary battery is described with reference to FIG. 22. FIG. 22A shows an external view of a cylindrical secondary battery 600. FIG. 22B is a schematic cross-sectional view of the cylindrical secondary battery 600. The cylindrical secondary battery 600 includes, as illustrated in FIG. 22B, a positive electrode cap (battery lid) 601 on the top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

Furthermore, as illustrated in FIG. 22C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 22D is a top view of the module 615. The conductive plate 613 is shown by a dotted line for clarity of the drawing. As illustrated in FIG. 22D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high charge and discharge capacity and excellent cycle performance can be obtained.

### Structure Examples of Secondary Battery

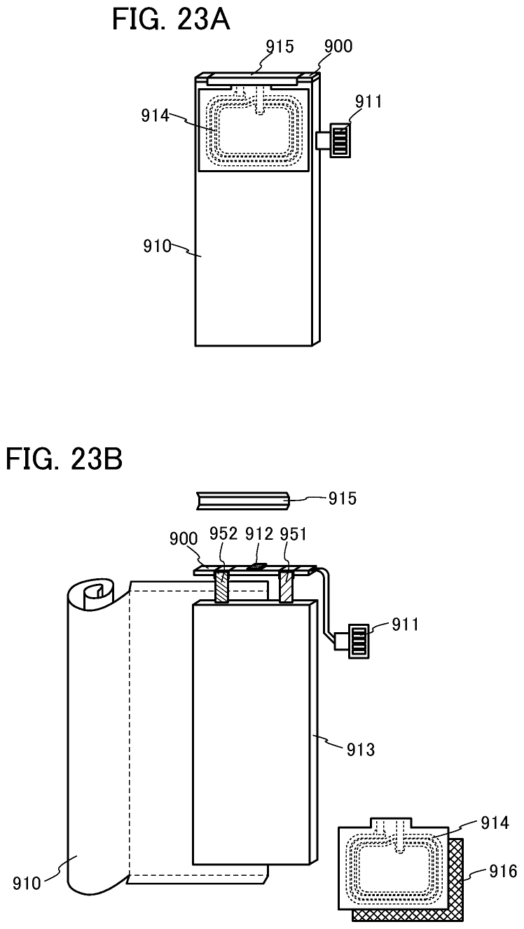

Other structure examples of secondary batteries are described with reference to FIG. 23 to FIG. 26.

FIG. 23A and FIG. 23B are external views of a battery pack. The battery pack includes a secondary battery 913 and a circuit board 900. The secondary battery 913 is connected to an antenna 914 through the circuit board 900. A label 910 is attached to the secondary battery 913. In addition, as illustrated in FIG. 23B, the secondary battery 913 is connected to a terminal 951 and a terminal 952. The circuit board 900 is fixed with a seal 915.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to coil shapes, and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

Note that the structure of the battery pack is not limited to that in FIG. 23.

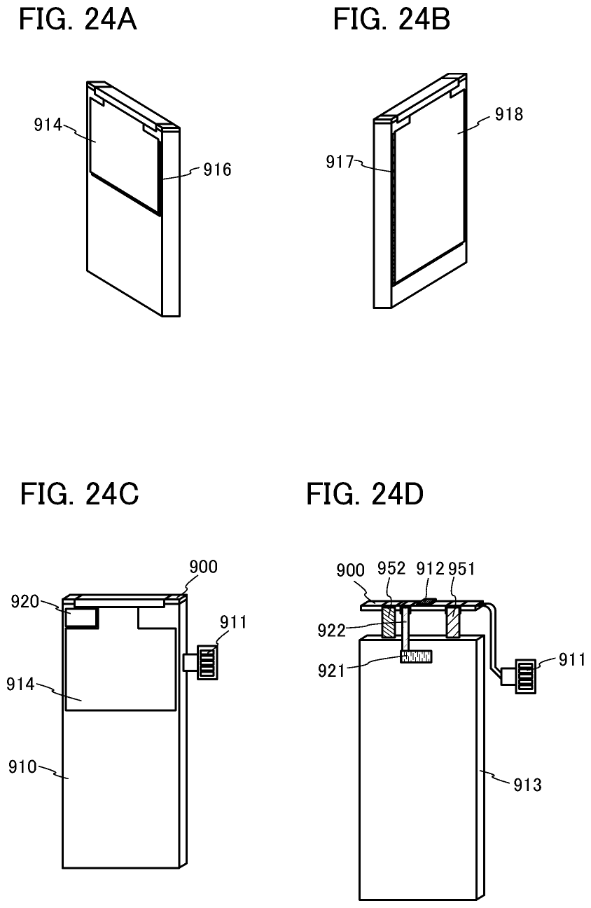

For example, as illustrated in FIG. 24A and FIG. 24B, two opposite surfaces of the secondary battery 913 illustrated in FIG. 23A and FIG. 23B may be provided with respective antennas. FIG. 24A is an external view seen from one side of the opposite surfaces, and FIG. 24B is an external view seen from the other side of the opposite surfaces. Note that for portions similar to those of the secondary battery illustrated in FIG. 23A and FIG. 23B, the description of the secondary battery illustrated in FIG. 23A and FIG. 23B can be appropriately referred to.

As illustrated in FIG. 24A, the antenna 914 is provided on one of the opposite surfaces of the secondary battery 913 with the layer 916 located therebetween, and as illustrated in FIG. 24B, an antenna 918 is provided on the other of the opposite surfaces of the secondary battery 913 with a layer 917 located therebetween. The layer 917 has a function of blocking an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 24C, the secondary battery 913 illustrated in FIG. 23A and FIG. 23B may be provided with a display device 920. The display device 920 is electrically connected to the terminal 911. Note that the label 910 is not necessarily provided in a portion where the display device 920 is provided. Note that for portions similar to those of the secondary battery illustrated in FIG. 23A and FIG. 23B, the description of the secondary battery illustrated in FIG. 23A and FIG. 23B can be appropriately referred to.

The display device 920 may display, for example, an image showing whether charge is being carried out, an image showing the amount of stored power, or the like. As the display device 920, electronic paper, a liquid crystal display device, an electroluminescent (also referred to as EL) display device, or the like can be used. For example, the use of electronic paper can reduce power consumption of the display device 920.

Alternatively, as illustrated in FIG. 24D, the secondary battery 913 illustrated in FIG. 23A and FIG. 23B may be provided with a sensor 921. The sensor 921 is electrically connected to the terminal 911 via a terminal 922. Note that for portions similar to those of the secondary battery illustrated in FIG. 23A and FIG. 23B, the description of the secondary battery illustrated in FIG. 23A and FIG. 23B can be appropriately referred to.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be detected and stored in a memory inside the circuit 912.

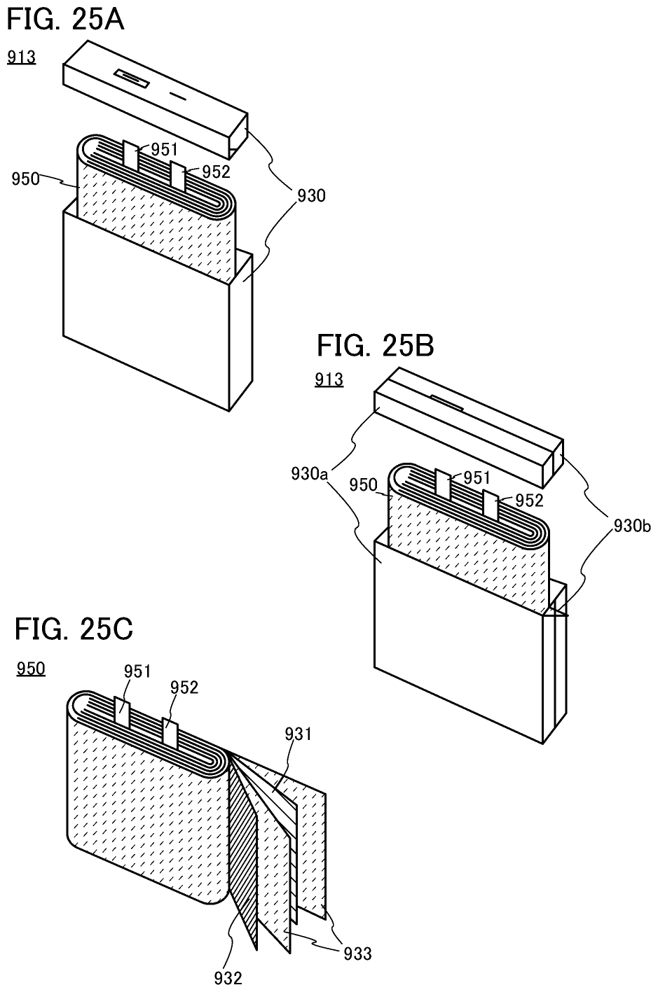

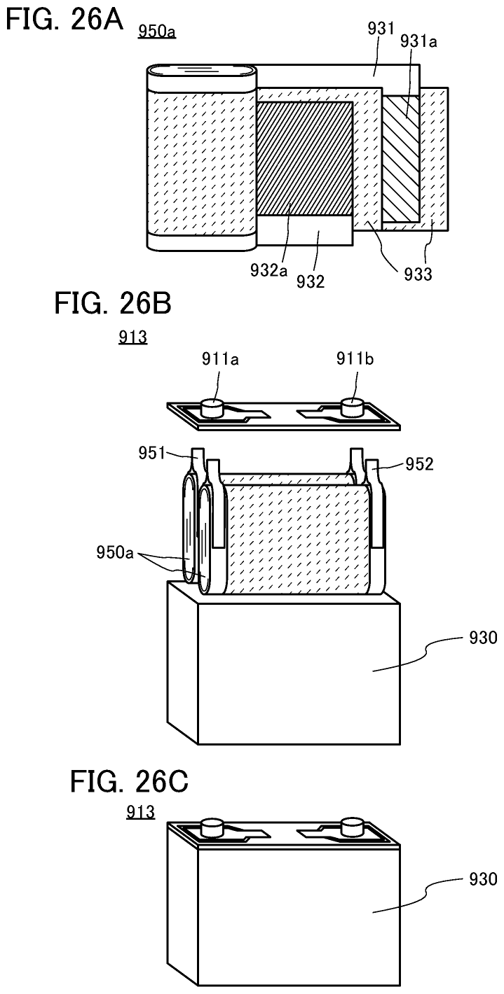

Furthermore, structure examples of the secondary battery 913 are described with reference to FIG. 25 and FIG. 26.

The secondary battery 913 illustrated in FIG. 25A includes a wound body 950 provided with the terminal 951 and the terminal 952 inside a housing 930. The wound body 950 is soaked in an electrolyte solution inside the housing 930. The terminal 952 is in contact with the housing 930. The use of an insulator or the like prevents contact between the terminal 951 and the housing 930. Note that in FIG. 25A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 25B, the housing 930 illustrated in FIG. 25A may be formed using a plurality of materials. For example, in the secondary battery 913 illustrated in FIG. 25B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 25C illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

The negative electrode 931 is connected to the terminal 911 illustrated in FIG. 23 via one of the terminal 951 and the terminal 952. The positive electrode 932 is connected to the terminal 911 illustrated in FIG. 23 via the other of the terminal 951 and the terminal 952.

As illustrated in FIG. 26A to FIG. 26C, the secondary battery 913 may include a wound body 950a. The wound body 950a illustrated in FIG. 26A includes the negative electrode 931, the positive electrode 932, and the separators 933. The negative electrode 931 includes a negative electrode active material layer 931a. The positive electrode 932 includes a positive electrode active material layer 932a. The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 26B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 26B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 25A to FIG. 25C can be referred to for the other components of the secondary battery 913 illustrated in FIG. 26A to FIG. 26C.

When the positive electrode active material described in the above embodiment is used in the positive electrode 932, the secondary battery 913 with high charge and discharge capacity and excellent cycle performance can be obtained.

### <Laminated Secondary Battery>

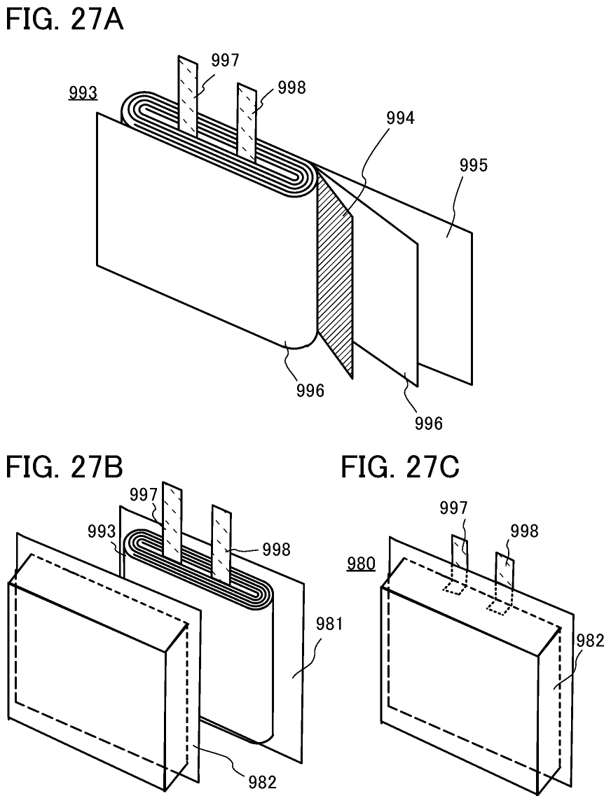

Next, an example of a laminated secondary battery is described with reference to FIG. 27 to FIG. 31. When the laminated secondary battery has flexibility and is used in an electronic device at least part of which is flexible, the secondary battery can be bent as the electronic device is bent.

A laminated secondary battery 980 is described with reference to FIG. 27. The laminated secondary battery 980 includes a wound body 993 illustrated in FIG. 27A. The wound body 993 includes a negative electrode 994, a positive electrode 995, and separators 996. The wound body 993 is, like the wound body 950 illustrated in FIG. 25C, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be designed as appropriate depending on required charge and discharge capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 27B, the above-described wound body 993 is packed in a space formed by bonding a film 981 and a film 982 having a depressed portion that serve as exterior bodies by thermocompression bonding or the like, whereby the secondary battery 980 as illustrated in FIG. 27C can be formed. The wound body 993 includes the lead electrode 997 and the lead electrode 998, and is soaked in an electrolyte solution inside the film 981 and the film 982 having a depressed portion.

For the film 981 and the film 982 having a depressed portion, a metal material such as aluminum and/or a resin material can be used, for example. With the use of a resin material for the film 981 and the film 982 having a depressed portion, the film 981 and the film 982 having a depressed portion can be changed in their forms when external force is applied; thus, a flexible storage battery can be formed.

Although FIG. 27B and FIG. 27C show an example of using two films, the wound body 993 may be placed in a space formed by bending one film.

When the positive electrode active material described in the above embodiment is used in the positive electrode 995, the secondary battery 980 with high charge and discharge capacity and excellent cycle performance can be obtained.

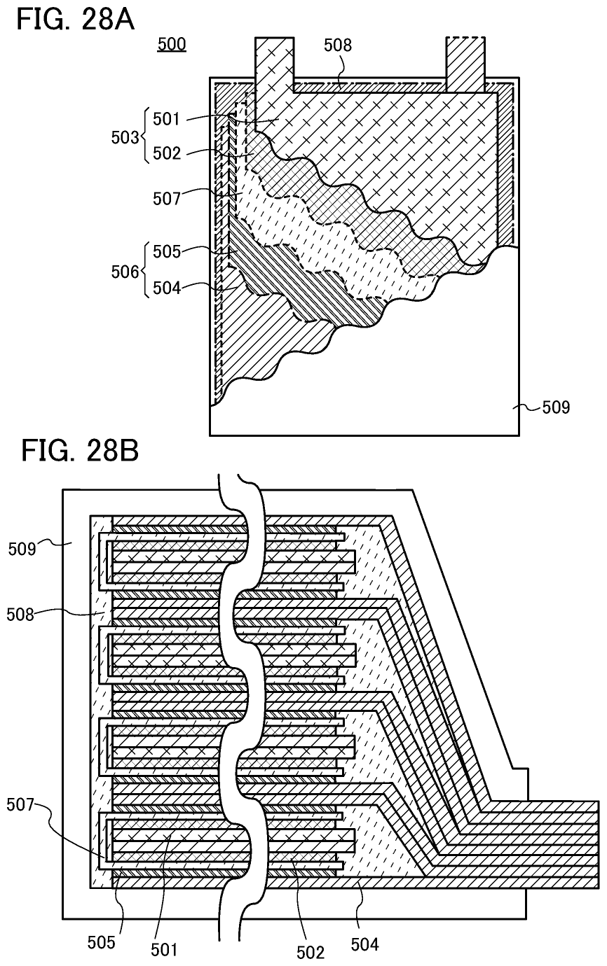

In FIG. 27, an example in which the secondary battery 980 includes a wound body in a space formed by films serving as exterior bodies is described; however, as illustrated in FIG. 28, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 28A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in the above embodiment can be used as the electrolyte solution 508.

In the laminated secondary battery 500 illustrated in FIG. 28A, the positive electrode current collector 501 and the negative electrode current collector 504 also serve as terminals for electrical contact with the outside. For this reason, the positive electrode current collector 501 and the negative electrode current collector 504 may be arranged such that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 28B illustrates an example of a cross-sectional structure of the laminated secondary battery 500. FIG. 28A illustrates an example in which only two current collectors are included for simplicity, but actually, a plurality of electrode layers are included as illustrated in FIG. 28B.

In FIG. 28B, the number of electrode layers is 16, for example. Note that the secondary battery 500 has flexibility even though the number of electrode layers is set to 16. FIG. 28B illustrates a structure including 8 layers of negative electrode current collectors 504 and 8 layers of positive electrode current collectors 501, i.e., 16 layers in total. Note that FIG. 28B illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high charge and discharge capacity. By contrast, with a small number of electrode layers, the secondary battery can have small thickness and high flexibility.

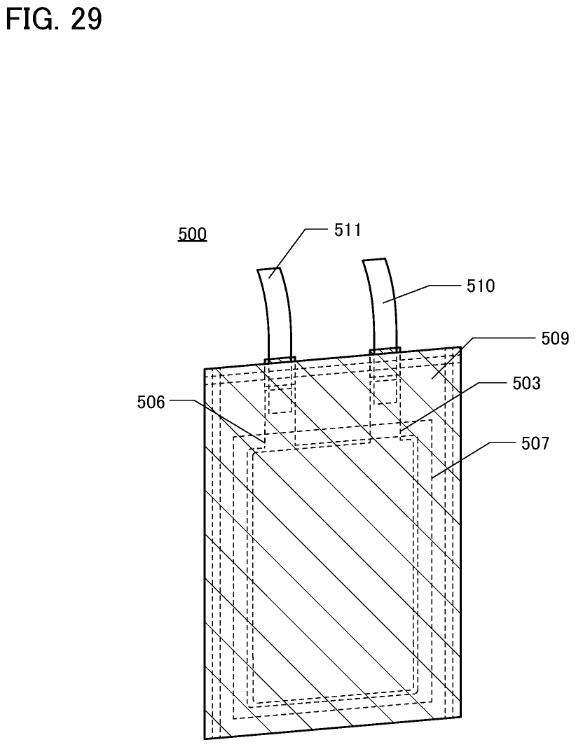

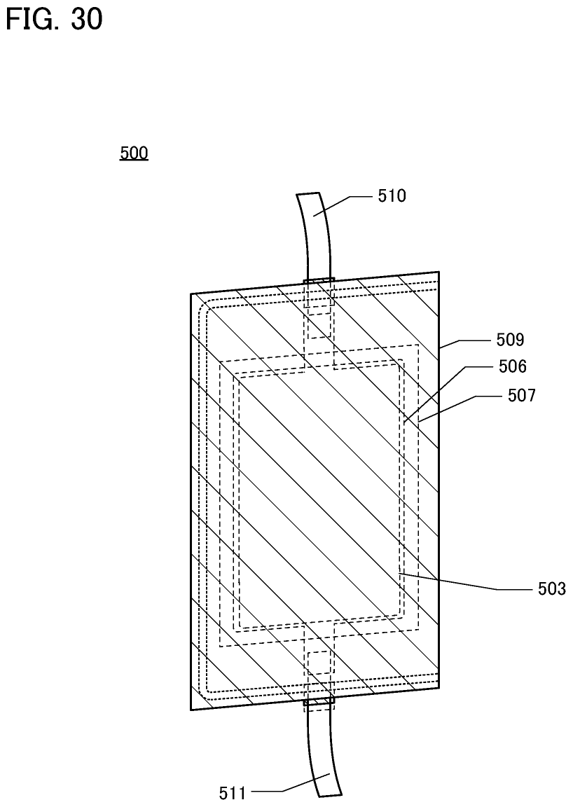

FIG. 29 and FIG. 30 each illustrate an example of the external view of the laminated secondary battery 500. In FIG. 29 and FIG. 30, the positive electrode 503, the negative electrode 506, the separator 507, the exterior body 509, a positive electrode lead electrode 510, and a negative electrode lead electrode 511 are included.

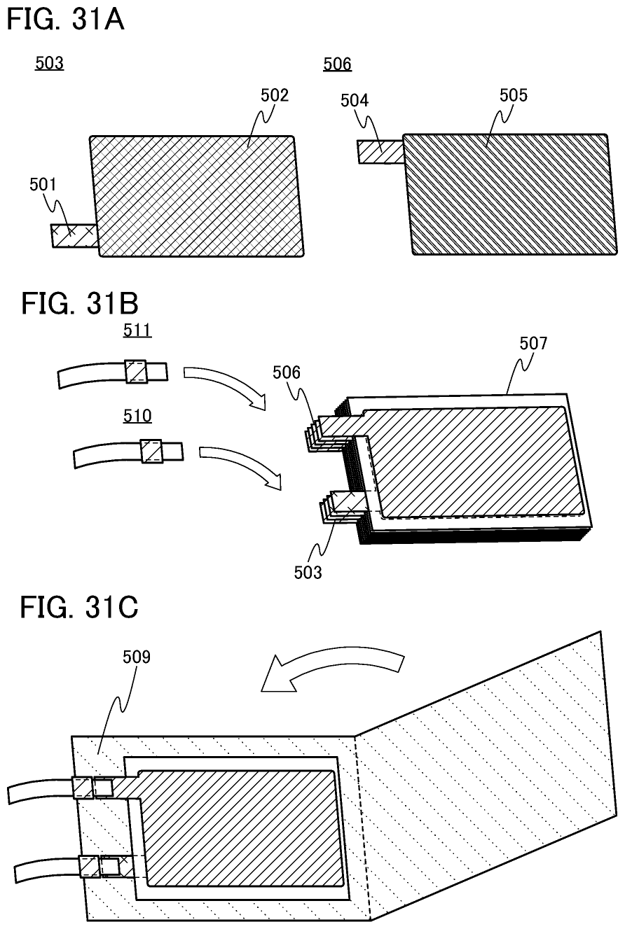

FIG. 31A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 31A.

### <Method for Forming Laminated Secondary Battery>

Here, an example of a method for forming the laminated secondary battery whose external view is illustrated in FIG. 29 is described with reference to FIG. 31B and FIG. 31C.

First, the negative electrode 506, the separator 507, and the positive electrode 503 are stacked. FIG. 31B illustrates a stack including the negative electrode 506, the separator 507, and the positive electrode 503. Here, an example in which 5 negative electrodes and 4 positive electrodes are used is shown. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a portion shown by a dashed line as illustrated in FIG. 31C. Then, the outer edges of the exterior body 509 are bonded to each other. The bonding can be performed by thermocompression bonding, for example. At this time, an unbonded region (hereinafter, referred to as an inlet) is provided for part (or one side) of the exterior body 509 so that the electrolyte solution 508 can be put later.

Next, the electrolyte solution 508 (not illustrated) is introduced into the exterior body 509 from the inlet of the exterior body 509. The electrolyte solution 508 is preferably introduced in a reduced pressure atmosphere or in an inert atmosphere. Lastly, the inlet is bonded. In the above manner, the laminated secondary battery 500 can be formed.

When the positive electrode active material described in the above embodiment is used in the positive electrode 503, the secondary battery 500 with high charge and discharge capacity and excellent cycle performance can be obtained.

This embodiment can be implemented in appropriate combination with any of the other embodiments.

### EMBODIMENT 5

In this embodiment, examples of electronic devices each including the secondary battery of one embodiment of the present invention are described.

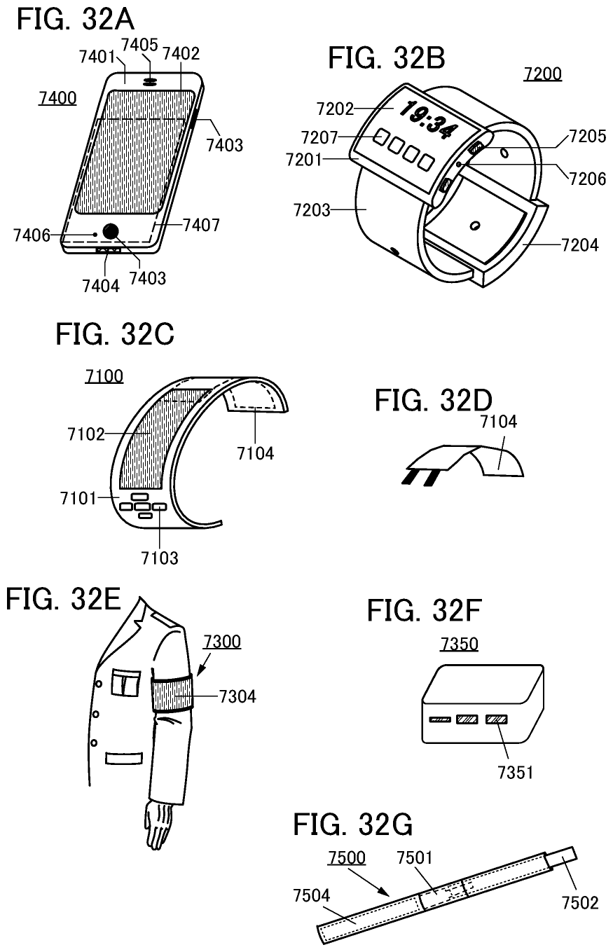

First, FIG. 32A to FIG. 32F illustrate examples of electronic devices each including the secondary battery described in the above embodiment. Examples of electronic devices each including the secondary battery described in the above embodiment include television sets (also referred to as televisions or television receivers), monitors of computers or the like, digital cameras, digital video cameras, digital photo frames, mobile phones (also referred to as cellular phones or mobile phone devices), portable game machines, portable information terminals, portable batteries, audio reproducing devices, and large game machines such as pachinko machines.

FIG. 32A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 32B illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charging via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, a secondary battery 7104 illustrated in FIG. 32D that is in the state of being curved can be provided in the housing 7201. Alternatively, the secondary battery 7104 illustrated in FIG. 32D can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 32C illustrates an example of a bangle display device. A portable display device 7100 includes a housing 7101, a display portion 7102, operation buttons 7103, and the secondary battery 7104. FIG. 32E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 32E illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charging via the input/output terminal is possible. Note that the charging operation may be performed by wireless power feeding without using the input/output terminal.

When the secondary battery of one embodiment of the present invention is used as the secondary battery included in the display device 7300, a lightweight display device with a long lifetime can be provided.

FIG. 32F illustrates an example of a mobile battery. A mobile battery 7350 includes a secondary battery and a plurality of terminals 7351. Another electronic device can be charged through the terminal 7351. When the secondary battery of one embodiment of the present invention is used as the secondary battery of the mobile battery 7350, the lightweight mobile battery 7350 with a long lifetime can be provided.

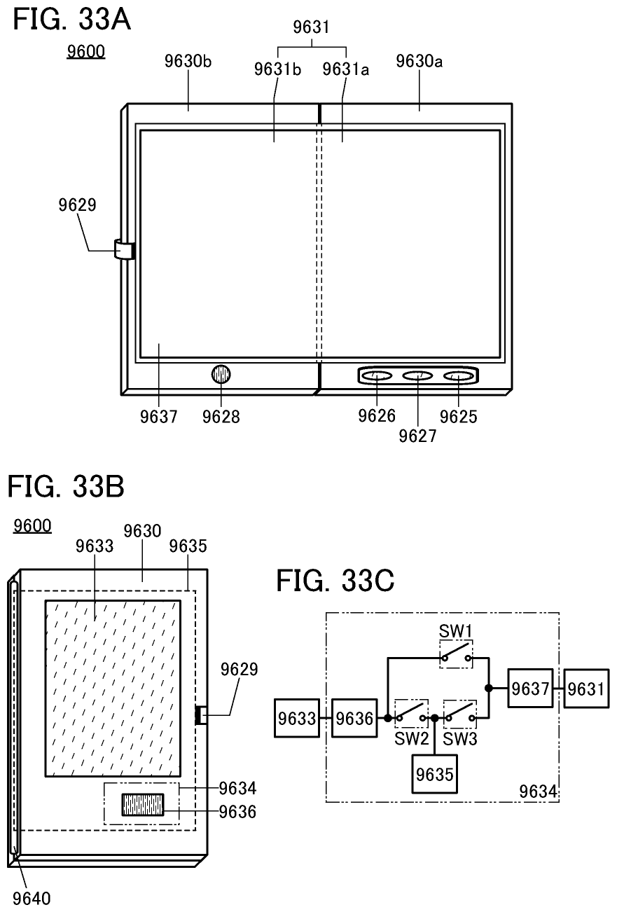

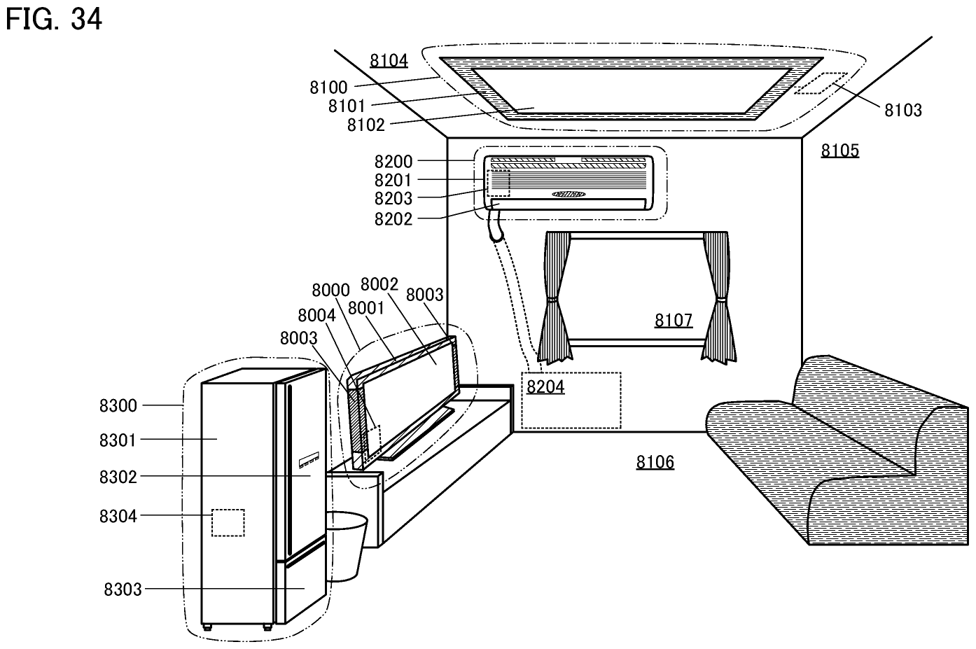

Examples of electronic devices each including the secondary battery with excellent cycle performance described in the above embodiment are described with reference to FIG. 32G, FIG. 33, and FIG. 34.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high charge and discharge capacity are desired in consideration of handling ease for users.

FIG. 32G is a perspective view of a device called a cigarette smoking device (electronic cigarette). In FIG. 32G, an electronic cigarette 7500 includes an atomizer 7501 including a heating element, a secondary battery 7504 that supplies electric power to the atomizer, and a cartridge 7502 including a liquid supply bottle, a sensor, and the like. To improve safety, a protection circuit that prevents overcharge and/or overdischarge of the secondary battery 7504 may be electrically connected to the secondary battery 7504. The secondary battery 7504 illustrated in FIG. 32G includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high charge and discharge capacity and excellent cycle performance, the small and lightweight electronic cigarette 7500 that can be used for a long time over a long period can be provided.

Next, FIG. 33A and FIG. 33B illustrate an example of a tablet terminal that can be folded in half. A tablet terminal 9600 illustrated in FIG. 33A and FIG. 33B includes a housing 9630a, a housing 9630b, a movable portion 9640 connecting the housing 9630a and the housing 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 33A illustrates the tablet terminal 9600 that is opened, and FIG. 33B illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

It is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display a keyboard on the display portion 9631.

Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may function as a switch for switching power on/off of the tablet terminal 9600. For another example, at least one of the switch 9625 to the switch 9627 may have a function of switching the display orientation between a portrait mode and a landscape mode and a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 33A illustrates an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different sizes or different display quality. For example, one may be a display panel that can display higher-definition images than the other.

The tablet terminal 9600 is folded in half in FIG. 33B. The tablet terminal 9600 includes a housing 9630, a solar cell 9633, and a charge and discharge control circuit 9634 including a DCDC converter 9636. The power storage unit of one embodiment of the present invention is used as the power storage unit 9635.

Note that as described above, the tablet terminal 9600 can be folded in half, and thus can be folded when not in use such that the housing 9630a and the housing 9630b overlap with each other. By the folding, the display portion 9631 can be protected, which increases the durability of the tablet terminal 9600. With the power storage unit 9635 including the secondary battery of one embodiment of the present invention, which has high charge and discharge capacity and excellent cycle performance, the tablet terminal 9600 that can be used for a long time over a long period can be provided.

The tablet terminal 9600 illustrated in FIG. 33A and FIG. 33B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, can supply electric power to a touch panel, a display portion, a video signal processing portion, and the like. Note that the solar cell 9633 can be provided on one surface or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 33B are described with reference to a block diagram in FIG. 33C. The solar cell 9633, the power storage unit 9635, the DCDC converter 9636, a converter 9637, switches SW1 to SW3, and the display portion 9631 are illustrated in FIG. 33C, and the power storage unit 9635, the DCDC converter 9636, the converter 9637, and the switches SW1 to SW3 correspond to the charge and discharge control circuit 9634 illustrated in FIG. 33B.

First, an operation example in which electric power is generated by the solar cell 9633 using external light is described. The voltage of electric power generated by the solar cell is raised or lowered by the DCDC converter 9636 to voltage for charging the power storage unit 9635. When the display portion 9631 is operated with the electric power from the solar cell 9633, the switch SW1 is turned on and the voltage is raised or lowered by the converter 9637 to voltage needed for the display portion 9631. When display on the display portion 9631 is not performed, the switch SW1 is turned off and the switch SW2 is turned on, so that the power storage unit 9635 is charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the charging may be performed with a non-contact power transmission module that performs charging by transmitting and receiving electric power wirelessly (without contact), or with a combination of other charge units.

FIG. 34 illustrates other examples of electronic devices. In FIG. 34, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 34, an installation lighting device 8100 is an example of an electronic device including a secondary battery 8103 of one embodiment of the present invention. Specifically, the lighting device 8100 includes a housing 8101, alight source 8102, the secondary battery 8103, and the like. Although FIG. 34 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 34 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 34, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 34 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 34 as an example, the secondary battery of one embodiment of the present invention can be used in an air conditioner in which the function of an indoor unit and the function of an outdoor unit are integrated in one housing.

In FIG. 34, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 34. The electric refrigerator-freezer 8300 can be supplied with electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Therefore, the tripping of a breaker of a commercial power supply in use of the electronic device can be prevented by using the secondary battery of one embodiment of the present invention as an auxiliary power supply for supplying electric power that cannot be supplied enough by a commercial power supply.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high charge and discharge capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with any of the other embodiments.

### EMBODIMENT 6

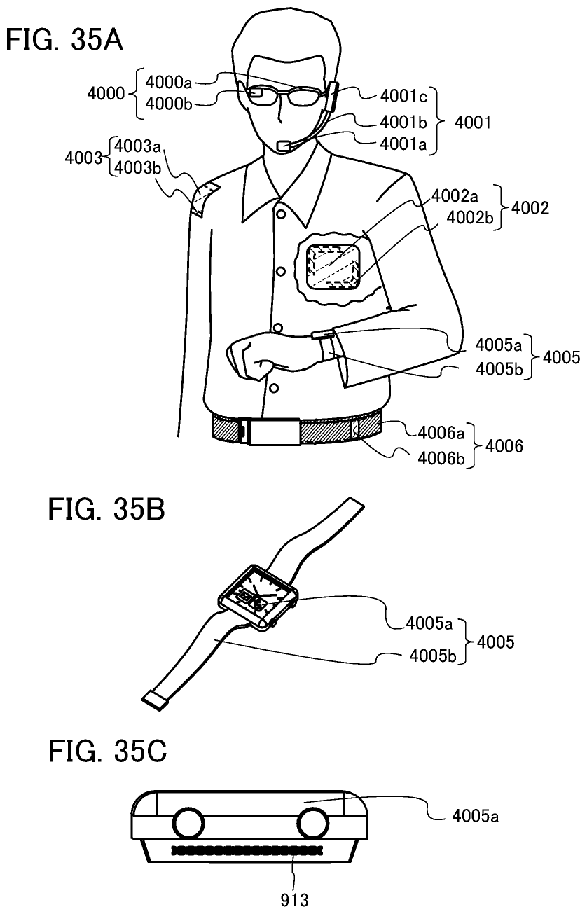

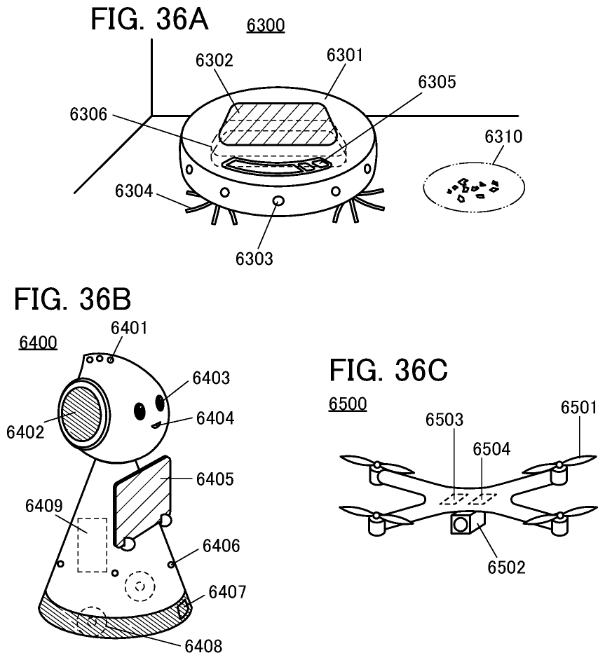

In this embodiment, examples of electronic devices each including the secondary battery described in the above embodiment are described with reference to FIG. 35 and FIG. 36.

FIG. 35A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 35A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for along time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 35B is a perspective view of the watch-type device 4005 that is detached from an arm.

FIG. 35C is a side view. FIG. 35C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 36A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 36B illustrates an example of a robot. A robot 6400 illustrated in FIG. 36B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 36C illustrates an example of a flying object. A flying object 6500 illustrated in FIG. 36C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### EMBODIMENT 7

In this embodiment, examples of vehicles each including the secondary battery of one embodiment of the present invention are described.

The use of secondary batteries in vehicles enables production of next-generation clean energy vehicles such as hybrid electric vehicles (HVs), electric vehicles (EVs), and plug-in hybrid electric vehicles (PHVs).

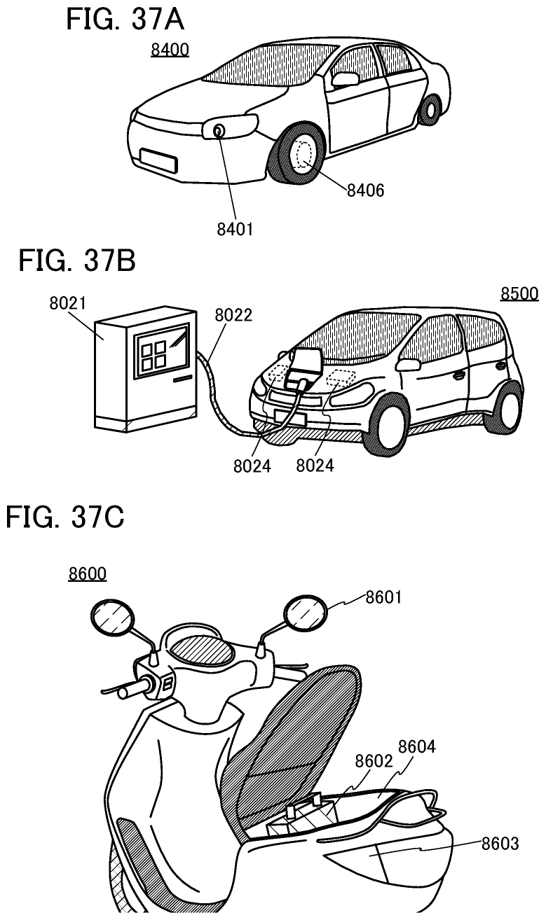

FIG. 37 illustrates examples of a vehicle including the secondary battery of one embodiment of the present invention. An automobile 8400 illustrated in FIG. 37A is an electric vehicle that runs on the power of an electric motor. Alternatively, the automobile 8400 is a hybrid electric vehicle capable of driving using either an electric motor or an engine as appropriate. The use of one embodiment of the present invention achieves a high-mileage vehicle. The automobile 8400 includes the secondary battery. As the secondary battery, the modules of the secondary batteries illustrated in FIG. 22C and FIG. 22D may be arranged to be used in a floor portion in the automobile. Alternatively, a battery pack in which a plurality of secondary batteries illustrated in FIG. 25 are combined may be placed in the floor portion in the automobile. The secondary battery can be used not only for driving an electric motor 8406, but also for supplying electric power to light-emitting devices such as a headlight 8401 and a room light (not illustrated).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 37B can be charged when the secondary battery included in the automobile 8500 is supplied with electric power through external charge equipment by a plug-in system, a contactless power feeding system, and/or the like. FIG. 37B illustrates a state where a secondary battery 8024 included in the automobile 8500 is charged with the use of a ground-based charging apparatus 8021 through a cable 8022. Charging can be performed as appropriate by a given method such as CHAdeMO (registered trademark) and Combined Charging System as a charging method, the standard of a connector, and the like. The charging apparatus 8021 may be a charge station provided in a commerce facility or a power supply in a house. For example, with the use of a plug-in technique, the secondary battery 8024 included in the automobile 8500 can be charged by being supplied with electric power from outside. The charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and moves. To supply electric power in such a contactless manner, an electromagnetic induction method and/or a magnetic resonance method can be used.

FIG. 37C illustrates an example of a motorcycle including the secondary battery of one embodiment of the present invention. A motor scooter 8600 illustrated in FIG. 37C includes a secondary battery 8602, side mirrors 8601, and direction indicators 8603. The secondary battery 8602 can supply electric power to the direction indicators 8603.

In the motor scooter 8600 illustrated in FIG. 37C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the charge and discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over along period; thus, the use amount of rare metals typified by cobalt can be reduced.

This embodiment can be implemented in appropriate combination with any of the other embodiments.

### EXAMPLE 1

In this example, the positive electrode active material 100 of one embodiment of the present invention and a positive electrode active material of a comparative example were formed, and their shapes were analyzed.

### <Formation of Positive Electrode Active Material>

Samples formed in this example are described with reference to the formation methods shown in FIG. 13 and FIG. 14.

As the LiMO₂ in Step S14 in FIG. 13, with the use of cobalt as the transition metal M, a commercially available lithium cobalt oxide (Cellseed C-10N produced by NIPPON CHEMICAL INDUSTRIAL CO., LTD.) not containing any additive was prepared. Lithium fluoride and magnesium fluoride were mixed therewith by a solid phase method, as in Step S21 to Step S23 and Step S41 and Step S42. Lithium fluoride and magnesium fluoride were added such that the molecular weight of lithium fluoride was 0.17 and the molecular weight of magnesium fluoride was 0.5 with the number of cobalt atoms regarded as 100. The mixture here is the mixture 903.

Next, annealing was performed in a manner similar to that of Step S43. In an alumina crucible, approximately 1.2 g of the mixture was placed, a lid was put on the crucible, and heating was performed in a muffle furnace. The flow rate of oxygen was 10 L/min. The annealing temperature was 850° C., and the annealing time was 60 hours.

The thus formed positive electrode active material was used as Sample 1.

Next, as the LiMO₂ in Step S14 in FIG. 14, Cellseed C-10N was similarly prepared. Lithium fluoride, magnesium fluoride, aluminum hydroxide, and nickel hydroxide were mixed therewith by a solid phase method, as in Step S21 to Step S23, Step S31, Step S32, Step S41, and Step S42. Lithium fluoride, magnesium fluoride, aluminum hydroxide, and nickel hydroxide were added such that the molecular weight of lithium fluoride was 0.33, the molecular weight of magnesium fluoride was 1.0, the atomic weight of nickel was 0.5, and the atomic weight of aluminum was 0.5 with the number of cobalt atoms regarded as 100. The mixture here is the mixture 903.

Next, annealing was performed in a manner similar to that of Step S43. In a square-shaped alumina container, approximately 10 g of the mixture was placed, a lid was put on the container, and heating was performed in a muffle furnace. The flow rate of oxygen was 10 L/min. The annealing temperature was 850° C., and the annealing time was 60 hours.

The thus formed positive electrode active material was used as Sample 2.

Cellseed C-10N was used as lithium cobalt oxide containing cobalt as the transition metal M and not containing any additive, which is Sample 3 (comparative example).

Table 4 shows the formation conditions of Sample 1 to Sample 3.

TABLE 4

| | Transition metal | Additive element | Annealing |
|---|---|---|---|
| Sample 1 | Co | Mg, F | 850° C., 60 h |
| Sample 2 | Co, Ni | Mg, F, Al | 850° C., 60 h |
| Sample 3 | Co | — | — |
| (comparative | | | |
| example) | | | |

### <SEM Image Capturing>

Surface SEM images of the particles of Sample 1 to Sample 3 were captured. The image capturing was performed at an acceleration voltage of 5 kV with a working distance (WD) of 8 mm by an observation mode in which a secondary electron (SE) image and a high angle backscattered electron (HA-BSE) image were combined to increase the contrast between the particles and the background. The particles that did not overlap with other particles and fitted in one field of view at a magnification of 5 k were randomly selected and their images were captured. The number n of image-captured particles is 14 for Sample 1 and Sample 2, and is 12 for Sample 3 (comparative example).

### <Image Analysis>

The captured SEM images were subjected to image analysis using image analysis software ImageJ. First, the luminance was adjusted such that the outlines of the particles were clearly observed, and the binarized particle shapes were obtained. The area, circularity, solidity, and fractal dimension (D boxcount) of the particle shapes were calculated using the analysis function of ImageJ. Table 5, Table 6, Table 7, and Table 8 respectively show typical values of the area, the circularity, the solidity, and the fractal dimension. In each of Table 5 to Table 8, count represents the number n of image-captured particles, mean represents the average, std represents the standard deviation, min represents the minimum value, 25% represents the first quartile, 50% (median) represents the median value, 75% represents the third quartile, and max represents the maximum value.

TABLE 5
Area [um²]

| | | | | | | 50% | | |
|---|---|---|---|---|---|---|---|---|
| | count | mean | std | min | 25% | (median) | 75% | max |
| Sample 1 | 14 | 157.316 | 62.426 | 56.192 | 119.198 | 155.853 | 195.887 | 253.866 |
| Sample 2 | 14 | 116.293 | 66.262 | 22.282 | 85.612 | 103.105 | 133.383 | 282.291 |
| Sample 3 | | | | | | | | |
| (comparative | 12 | 171.783 | 55.955 | 99.380 | 151.833 | 157.113 | 177.499 | 295.619 |
| example) | | | | | | | | |

TABLE 6
Circularity

| | | | | | | 50% | | |
|---|---|---|---|---|---|---|---|---|
| | count | mean | std | min | 25% | (median) | 75% | max |
| Sample 1 | 14 | 0.741 | 0.078 | 0.538 | 0.738 | 0.761 | 0.787 | 0.831 |
| Sample 2 | 14 | 0.759 | 0.065 | 0.632 | 0.716 | 0.781 | 0.803 | 0.855 |
| Sample 3 | 12 | 0.708 | 0.078 | 0.552 | 0.673 | 0.696 | 0.770 | 0.828 |
| (comparative | | | | | | | | |
| example) | | | | | | | | |

TABLE 7
Solidity

| | | | | | | 50% | | |
|---|---|---|---|---|---|---|---|---|
| | count | mean | std | min | 25% | (median) | 75% | max |
| Sample 1 | 14 | 0.964 | 0.019 | 0.915 | 0.956 | 0.971 | 0.974 | 0.984 |
| Sample 2 | 14 | 0.963 | 0.029 | 0.891 | 0.966 | 0.972 | 0.977 | 0.988 |
| Sample 3 | 12 | 0.947 | 0.041 | 0.841 | 0.935 | 0.959 | 0.976 | 0.984 |
| (comparative | | | | | | | | |
| example) | | | | | | | | |

TABLE 8
D_boxcount: fractal dimension

| | | | | | | 50% | | |
|---|---|---|---|---|---|---|---|---|
| | count | mean | std | min | 25% | (median) | 75% | max |
| Sanple 1 | 14 | 1.140 | 0.016 | 1.118 | 1.126 | 1.141 | 1.150 | 1.169 |
| Sanple 2 | 14 | 1.138 | 0.013 | 1.105 | 1.131 | 1.139 | 1.147 | 1.156 |
| Sanple 3 | 12 | 1.145 | 0.012 | 1.124 | 1.139 | 1.144 | 1.149 | 1.169 |
| (comparative | | | | | | | | |
| example) | | | | | | | | |

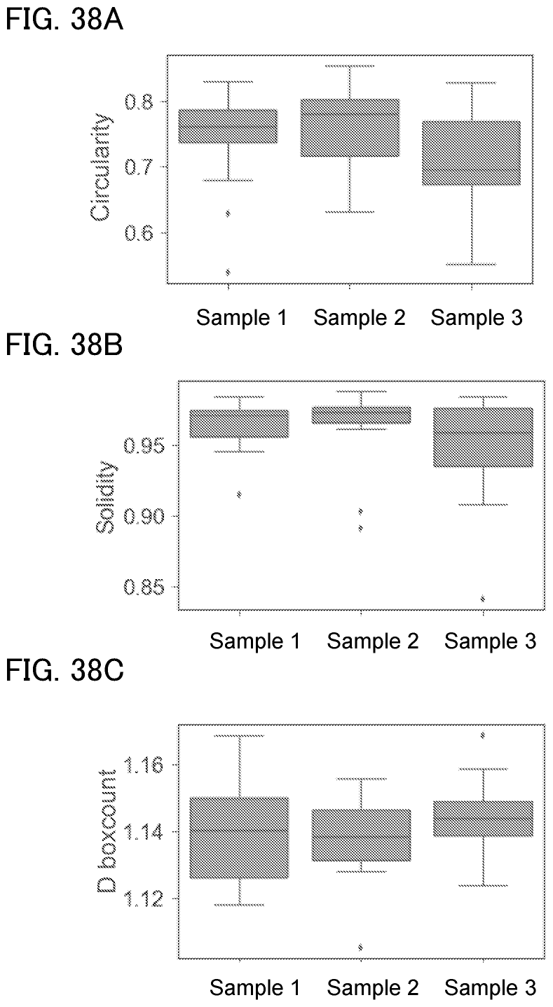

FIG. 38A, FIG. 38B, and FIG. 38C respectively show box and whisker plots of the circularity, the solidity, and the fractal dimension. The box and whisker plots were drawn using seaborn, which is one library of Python, on Jupyter Notebook. In each box and whisker plot, the interquartile range (IQR)=75 percentile (the third quartile)—25 percentile (the first quartile) is drawn as a box, and a line is drawn at the median value. In this example, “first quartile—1.5×IQR” is the lower limit of the whisker, “third quartile+1.5×IQR” is the upper limit of the whisker, and values smaller than the lower whisker and values larger than the upper whisker are denoted by dots as “outliers”.

As shown in FIG. 38A and Table 6, the median values of the circularity of Sample 1 and Sample 2, each of which is the positive electrode active material of one embodiment of the present invention, are larger than or equal to 0.7. Meanwhile, the median value of Sample 3 of the comparative example is 0.696, which is smaller than 0.7.

As shown in FIG. 38B and Table 7, the median values of the solidity of both Sample 1 and Sample 2 are larger than or equal to 0.96. Meanwhile, the median value of Sample 3 of the comparative example is 0.959, which is smaller than 0.96. In addition, Sample 1 and Sample 2 tend to have narrow distribution; the difference between the first quartile and the third quartile is 0.018 in Sample 1 and 0.011 in Sample 2. By contrast, Sample 3 has broad distribution; the difference between the first quartile and the third quartile is 0.041.

As shown in FIG. 38C and Table 8, the median values of the fractal dimension (D_{boxcount}) of both Sample 1 and Sample 2 are smaller than or equal to 1.143. Meanwhile, the median value of Sample 3 of the comparative example is 1.144.

### <Charge and Discharge Characteristics and Cycle Performance>

Secondary batteries were fabricated using the positive electrode active materials of Sample 1 to Sample 3, and their charge and discharge characteristics and cycle performance were evaluated. First, each of the positive electrode active materials of Sample 1 to Sample 3, AB, and PVDF were mixed at a weight ratio of 95:3:2 to form a slurry, and the slurries were applied to aluminum current collectors. As a solvent of the slurries, NMP was used.

After the slurry was applied onto the current collector, the solvent was volatilized. Then, pressure was applied at 210 kN/m, and then pressure was applied at 1467 kN/m. Through the above process, the positive electrode was obtained. The carried amount of the positive electrode was approximately 7 mg/cm².

Using the formed positive electrodes, CR2032 type coin battery cells (a diameter of 20 mm, a height of 3.2 mm) were formed.

A lithium metal was used for a counter electrode.

As an electrolyte contained in an electrolyte solution, 1 mol/L lithium hexafluorophosphate (LiPF₆) was used. As the electrolyte solution, a solution which is obtained by adding vinylene carbonate (VC) at 2 wt % to a mixture of ethylene carbonate (EC) and diethyl carbonate (DEC) at EC:DEC=3:7 (volume ratio) was used.

As a separator, 25-μm-thick polypropylene was used.

A positive electrode can and a negative electrode can that were formed using stainless steel (SUS) were used.

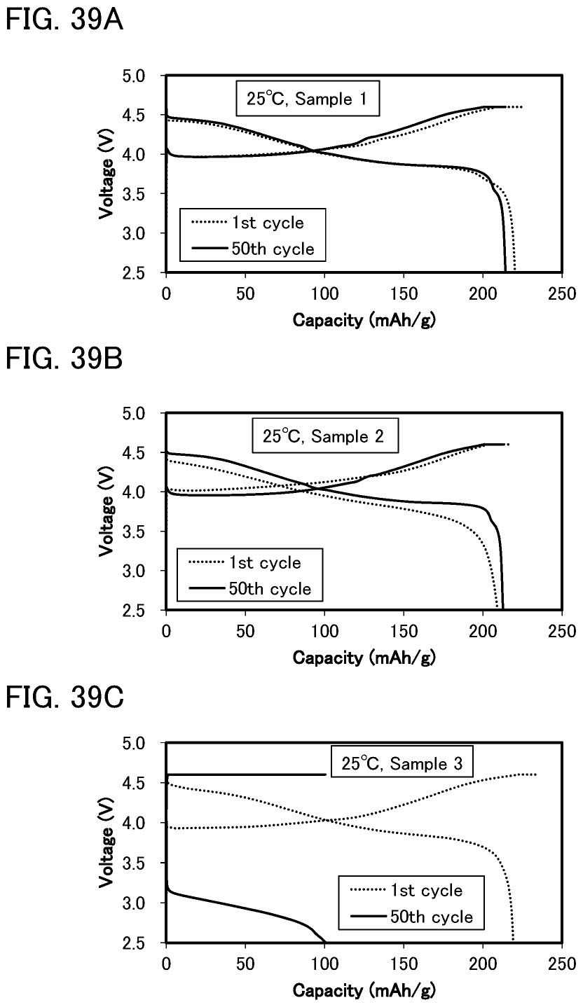

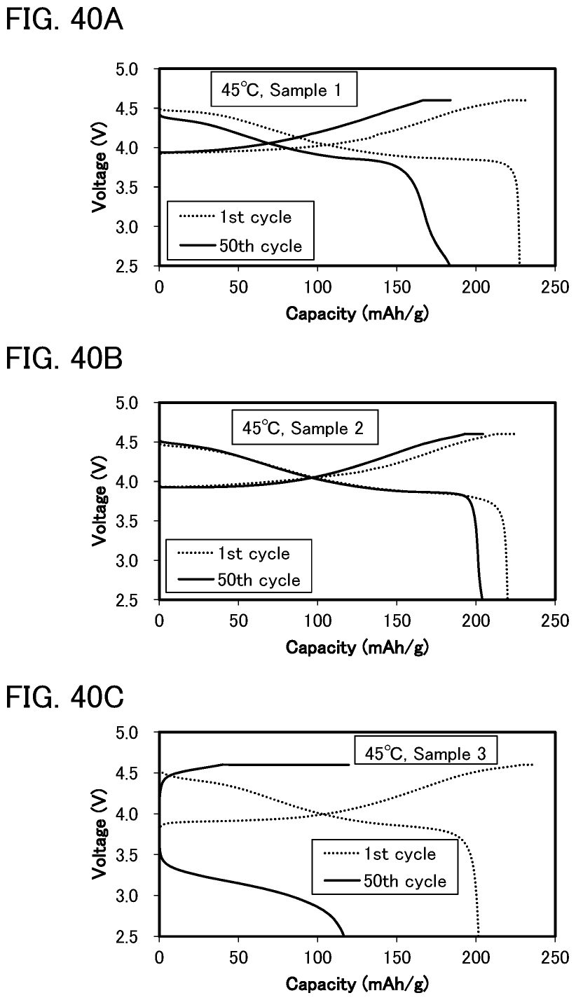

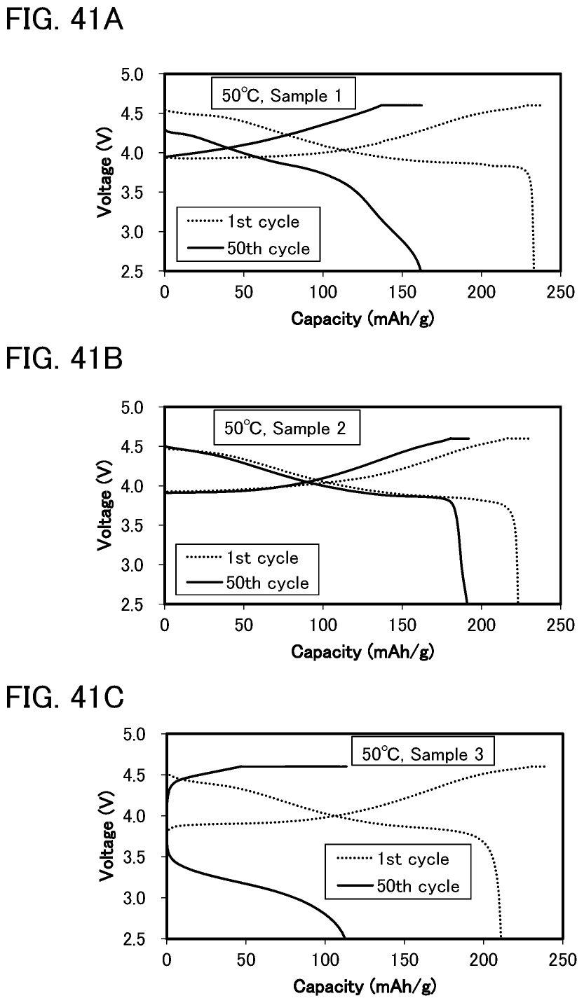

FIG. 39A to FIG. 41C show the initial charge and discharge curves (1st cycle) and the 50th charge and discharge curves (50th cycle). FIG. 39A to FIG. 39C show the measurement results at 25° C. FIG. 40A to FIG. 40C show the measurement results at 45° C. FIG. 41A to FIG. 41C show the measurement results at 50° C. A, B, and C in FIG. 39 to FIG. 41 show the results of Sample 1, Sample 2, and Sample 3, respectively.

CC/CV charging (0.5 C, 4.6 V, 0.05 C cut) and CC discharging (0.5 C, 2.5 V cut) were performed, and a 10-minute break was taken after each of charging and discharging. Note that 1 C was 200 mA/g in this example and the like.

As shown in FIG. 39A and FIG. 39B, Sample 1 and Sample 2, each of which is the positive electrode active material of one embodiment of the present invention, exhibited extremely favorable cycle performance after 50 cycles even with charging at a high voltage of 4.6 V. Particularly in Sample 2 containing nickel and aluminum, the discharge capacity after 50 cycles was higher than the initial discharge capacity.

In the measurement at 25° C., the initial discharge capacity of Sample 1 was 220 mAh/g, the discharge capacity at the 50th cycle was 214 mAh/g, and the discharge capacity retention rate after 50 cycles was 97.3%. The initial discharge capacity of Sample 2 was 209 mAh/g, the discharge capacity at the 50th cycle was 213 mAh/g, and the discharge capacity retention rate after 50 cycles was 102%.

Meanwhile, the charge and discharge characteristics of Sample 3 with an insufficiently smooth surface degraded as shown in FIG. 39C; the initial discharge capacity was 219 mAh/g, the discharge capacity at the 50th cycle was 101 mAh/g, and the discharge capacity retention rate after 50 cycles was 46.1%.

As shown in FIG. 40A and FIG. 40B, Sample 1 and Sample 2 exhibited excellent charge and discharge characteristics after 50 cycles even under the conditions where the temperature is 45° C., which is higher than room temperature. Sample 2 had especially excellent characteristics.

In the measurement at 45° C., the initial discharge capacity of Sample 1 was 228 mAh/g, the discharge capacity at the 50th cycle was 183 mAh/g, and the discharge capacity retention rate after 50 cycles was 80.7%. The initial discharge capacity of Sample 2 was 219 mAh/g, the discharge capacity at the 50th cycle was 204 mAh/g, and the discharge capacity retention rate after 50 cycles was 92.7%.

Meanwhile, the charge and discharge characteristics of Sample 3 degraded as shown in FIG. 40C; the initial discharge capacity was 202 mAh/g, the discharge capacity at the 50th cycle was 117 mAh/g, and the discharge capacity retention rate after 50 cycles was 57.9%.

As shown in FIG. 41A and FIG. 41B, Sample 1 and Sample 2 exhibited excellent charge and discharge characteristics after 50 cycles even under the conditions where the temperature is 50° C., which is much higher than room temperature. Sample 2 had especially excellent characteristics.

In the measurement at 50° C., the initial discharge capacity of Sample 1 was 233 mAh/g, the discharge capacity at the 50th cycle was 161 mAh/g, and the discharge capacity retention rate after 50 cycles was 69%. The initial discharge capacity of Sample 2 was 223 mAh/g, the discharge capacity at the 50th cycle was 191 mAh/g, and the discharge capacity retention rate after 50 cycles was 86%.

Meanwhile, the charge and discharge characteristics of Sample 3 degraded as shown in FIG. 41C; the initial discharge capacity was 211 mAh/g, the discharge capacity at the 50th cycle was 112 mAh/g, and the discharge capacity retention rate after 50 cycles was 53%.

The above results demonstrate that a positive electrode active material with a smooth surface and excellent cycle performance can be formed by mixing an additive with lithium cobalt oxide not containing an impurity element or the like and then heating the mixture.

### REFERENCE NUMERALS

90: vacuum region, 99: positive electrode active material of comparative example, 100: positive electrode active material, 100a: surface portion, 100b: inner portion, 101: crystal grain boundary, 102: crack, 103: projection and depression

1. A positive electrode active material comprising lithium and a transition metal, wherein a median value of solidity is larger than or equal to 0.96.

2. A positive electrode active material comprising lithium and a transition metal, wherein a difference between a first quartile and a third quartile of solidity is less than or equal to 0.04.

3. A positive electrode active material comprising lithium and a transition metal, wherein a median value of fractal dimension is smaller than or equal to 1.143.

4. A positive electrode active material comprising lithium and a transition metal, wherein a median value of circularity is larger than or equal to 0.7.

5. The positive electrode active material according to claim 1, further comprising halogen.

6. The positive electrode active material according to claim 5, wherein the halogen is fluorine.

7. The positive electrode active material according to claim 1, further comprising magnesium.

8. The positive electrode active material according to claim 1, further comprising nickel and aluminum.

9. A secondary battery comprising the positive electrode active material according to claim 1.

10. An electronic device comprising:
the secondary battery according to claim 9; and
any one of a circuit board, a sensor, and a display device.

11. The positive electrode active material according to claim 2, further comprising halogen.

12. The positive electrode active material according to claim 11, wherein the halogen is fluorine.

13. The positive electrode active material according to claim 2, further comprising magnesium.

14. The positive electrode active material according to claim 2, further comprising nickel and aluminum.

15. The positive electrode active material according to claim 3, further comprising halogen.

16. The positive electrode active material according to claim 15, wherein the halogen is fluorine.

17. The positive electrode active material according to claim 3, further comprising magnesium.

18. The positive electrode active material according to claim 3, further comprising nickel and aluminum.

19. The positive electrode active material according to claim 4, further comprising halogen.

20. The positive electrode active material according to claim 19, wherein the halogen is fluorine.

21. The positive electrode active material according to claim 4, further comprising magnesium.

22. The positive electrode active material according to claim 4, further comprising nickel and aluminum.
